(19) United States
(12) Patent Application Publication
(10) Pub. No.: US 2025/0264137 A1
(43) Pub. Date: Aug. 21, 2025

(54) ACTUATION MECHANISM

(71) Applicant: Means Industries, Inc., Saginaw, MI (US)

(72) Inventors: Robert B Larimer, Saginaw, MI (US); Gregory M Eisengruber, Saginaw, MI (US)

(73) Assignee: Means Industries, Inc., Saginaw, MI (US)

(21) Appl. No.: 19/203,697

(22) Filed: May 9, 2025

Related U.S. Application Data
(63) Continuation-in-part of application No. 18/566,855, filed on Dec. 4, 2023, now Pat. No. 12,305,716.
(60) Provisional application No. 63/253,401, filed on Oct. 7, 2021.

(51) Int. Cl. F16D 11/08; F16D 23/12

(52) U.S. Cl. CPC F16D 11/08; F16D 2023/123

(57) ABSTRACT

A clutch assembly, such as a controllable clutch, having an actuator for controlling coupling members for engagement and disengagement of components. The actuator includes a cam member with a first cam surface and a second cam surface. The first cam surface is spaced from the second cam surface. A first cam follower follows the first cam surface and a second cam follower follows the second cam surface. A first link extends between the first cam follower and a first coupling member, and a second link extends between the second cam follower and a second coupling member.

### CROSS-REFERENCE TO RELATED APPLICATIONS

This application is a continuation-in-part of U.S. patent application Ser. No. 18/566,855 filed on Dec. 4, 2023, which is a National Stage of International Application No. PCT/US 2022/046073, filed Oct. 7, 2022, and claims the benefit of U.S. Provisional Application No. 63/253,401, filed Oct. 7, 2021. The disclosure of the above applications are incorporated herein by reference.

### BACKGROUND OF THE INVENTION

### 1. Field of the Invention

The present invention generally relates to actuators for controlling engagement and disengagement of power components.

### 2. Description of Related Art

A one-way clutch (“OWC”) includes a first coupling member, a second coupling member, and at least one locking element between opposing surfaces of the coupling members. The locking element moves between a deployed or engaged position, in which the locking element extends from the first coupling member and engages the second coupling member, and a non-deployed or disengaged position in which the locking element does not extend from the first coupling member and does not engage the second coupling member. In the deployed position, the locking element engages the second coupling member wherein the OWC locks in one direction of rotation but has free rotation in the opposite direction.

A selectable OWC (“SOWC”) produces a mechanical connection between rotating or stationary components in one or both directions and can overrun in one or both directions. A selectable OWC, also known as a two-way clutch, adds a second set of locking elements in combination with a selector plate. The second set of locking elements, plus the selector plate, adds multiple functions to the OWC. The selector plate is adjustable between different positions to implement the different operating modes.

A dynamically controllable clutch or dynamic selectable clutch (“DCC”) fits in positions where typically dog clutches, synchronizers, and wet friction packs would be located.

FIGS. 1-5 show a DCC 12 according to the prior art. DCC 12 is a component of a system (not shown), such as an automotive transmission, further having an input power component (e.g., a drive shaft) and an output power component (e.g., a driven shaft).

The dynamically controllable clutch (DCC) 12 has a radially inner rotating race, i.e., a first coupling member in the form of a pocket plate 13 (FIGS. 4 and 5), and a radially outer rotating race, i.e., a second coupling member in the form of a notch plate 16. The pocket plate 13 is fixedly connected to a first power component of the system, and the notch plate 16 is fixedly connected to a second power component of the system. Consequently, the first and second power components are connected when pocket and notch plates 13 and 16 are connected.

The pocket plate 13 contains first and second sets of radial locking elements 26 for clockwise (“CW”) and counterclockwise (“CCW”) engagement, respectively. During engagement, at least one of the sets of locking elements 26 simultaneously contacts the pocket and notch engagement faces of the pocket and notch plates 13, 16, connecting the pocket and notch plates 13, 16 together. The pocket and notch plates 13, 16 connect the first and second power components. Consequently, in each locked direction of rotation, the DCC 12 transmits torque between the power components, which are connected via the connected pocket and notch plates 13 and 16.

DCC 12 is actuated by an actuation system in the form of a linear motor or linear actuator 14. The linear actuator 14 includes a stator 22 and a translator 20. Stator 22 is fixed in position, for example, to a transmission case (not shown) via mounts 47. The stator 22 includes a pair of copper wire induction coils 44, 46. Steel plates 48, 50, and 52 provide a housing for the stator coils 44, 46. The stator coils 44, 46 are wound in series with reversed polarity relative to one another, anti-series.

The translator 20 linearly moves between lateral, axial positions. The translator 20 is fixedly connected to and rotates with the pocket plate 13. The translator 20 includes an annular ring of segmented permanent magnets 21, steel plates 23, 25, and rigid plungers 30. The plungers 30 operate the locking elements 26. The plungers 30 extend through holes formed through a carriage 51 of the translator 20 and are biased by springs 34. The plungers 30 are threaded at their ends and secured within their holes by internally threaded nuts 35. The conical ends of plungers 30 extend through the apertures of a ring 55.

FIGS. 2-5 show the linear actuator 14 controlling the locking elements 26. Depending on actuation direction, the plungers 30 within the translator 20 directly contact the locking elements 26 and cause them to pitch up or down. The linear actuator 14 has an “off” position, shown in FIGS. 2 and 4, and an “on” position, shown in FIGS. 3 and 5. The linear actuator 14 switches between the “off” and “on” positions by causing the translator 20 to laterally move between, in this case, a right-most position, shown in FIGS. 2 and 4, and a left-most position shown in FIGS. 3 and 5.

When the translator 20 moves from “off” to “on,” each plunger 30 contacts the under face or surface of its locking element 26 so the locking element can engage the notch plate 16. The DCC 12 transmits torque in each locked direction of rotation when the locking elements 26 are engaged with notch plate 16. A return spring 28 under each locking element 26 is compressed during the engaged state. When commanded “off,” the translator 20 moves back toward the “off” position, and the plungers 30 lose contact with the locking elements 26. Compressed return springs 28 create a force causing the locking elements 26 to pitch downward or disengage. Once a torque reversal occurs, the locking elements 26 can disengage, and the DCC 12 can freewheel.

To change the state from “off” to “on,” an electrical current energizes the stator coil 46 nearest to the translator 20. The energized stator coil 46 produces a magnetic field that repels the steady state field generated by the permanent magnets 21, while the far stator coil 44 produces an attractive magnetic field. The combination of repelling and attracting forces caused by the stator coils 44 and 46 causes the translator 20 to move.

Once the translator 20 passes over the center stator steel plate 50, the permanent magnets 21 attempt to fully align the left-most stator steel plate 48. A mechanical stop 53, shown in FIGS. 4 and 5, prevents complete alignment, which results in a biasing force that holds the translator 20 in the “on” position. The translator 20 is magnetically latched in the “on” position.

To disengage the DCC 12, electrical current is applied to the stator coil 44 nearest to the translator 20, formerly the far stator coil 46, and the linear actuator 14 moves from the “on” stop 53 to a ring which functions as an “off” stop 42 in a similar manner described above. The “off” mechanical stop 42 prevents complete alignment of the permanent magnet 21 and the right-most stator steel plate 52, remaining magnetically latched in the “off” position.

### SUMMARY OF THE INVENTION

An actuation mechanism having an actuator for controlling the engagement and disengagement of power components.

The actuator includes a cam member having a first cam surface and a second cam surface, the first cam surface spaced from the second cam surface. A first cam follower, the first cam follower following the first cam surface, and a second cam follower, the second cam follower following the second cam surface. A first link extends between the first cam follower and a first coupling member, and a second link extends between the second cam follower and a second coupling member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings.

FIG. 1 is an exploded view of a dynamically controllable clutch (“DCC”) in accordance with the prior art.

FIG. 2 is a perspective view, partially broken away and in cross-section, of the prior art DCC with a linear actuator of the DCC being in an “off” position whereby the DCC is in a freewheel mode.

FIG. 3 is a perspective view, partially broken away and in cross-section, of the prior art DCC with the linear actuator being in an “on” position whereby the DCC is in a lock mode.

FIG. 4 is a side view, partially broken away and in cross-section, of the prior art DCC with a translator of the linear actuator magnetically latched in the “off” position, wherein FIGS. 2 and 4 pertain to the same condition of the DCC.

FIG. 5 is a side view, partially broken away and in cross-section, of the prior art DCC with the translator of the linear actuator magnetically latched in the “on” position, wherein FIGS. 3 and 5 pertain to the same condition of the DCC.

FIG. 6 is an exploded view, from the right side, of a system having an actuation mechanism according to one embodiment of the present invention.

FIG. 7 is a partial, exploded view, from the left side, of the system of FIG. 6.

FIG. 8 is a partial, cross-sectional view of the system of FIG. 6.

FIG. 9 is a partial, cross-sectional view of the system of FIG. 6.

FIG. 10 is a perspective view of one component of the actuation mechanism of FIG. 6.

FIG. 11 is a perspective view of another component of the actuation mechanism of FIG. 6.

FIG. 12 is a perspective view of the components of FIGS. 10 and 11 in an initial position.

FIG. 13 is a perspective view of the components of FIGS. 10 and 11 in an extended position.

FIG. 14 is an exploded view, from the right side, of a system having an actuation mechanism according to another embodiment of the present invention.

FIG. 15 is a partial, exploded view, from the left side, of the system of FIG. 14.

FIG. 16 is a partial, cross-sectional view of the system of FIG. 14.

FIG. 17 is a partial, cross-sectional view of the system of FIG. 14.

FIG. 18 is a perspective view of a component of the actuation mechanism of FIG. 14.

FIG. 19 is a perspective view of another component of the actuation mechanism of FIG. 14.

FIG. 20 is a perspective view of yet another component of the actuation mechanism of FIG. 14

FIG. 21 is a partial, perspective view of part of the actuation mechanism of FIG. 14 in a first mode.

FIG. 22 is a cross-sectional view of the actuation mechanism of FIG. 21.

FIG. 23 is a partial, perspective view of part of the actuation mechanism of FIG. 14 in a second mode.

FIG. 24 is a cross-sectional view of the actuation mechanism of FIG. 23.

FIG. 25 is a partial, perspective view of part of the actuation mechanism of FIG. 14 in a third mode.

FIG. 26 is a cross-sectional view of the actuation mechanism of FIG. 25.

FIG. 27 is a partial, perspective view of part of the actuation mechanism of FIG. 14 in a fourth mode.

FIG. 28 is a cross-sectional view of the actuation mechanism of FIG. 27.

FIG. 29 is a top view of part of the actuation mechanism of FIG. 14 with portions removed for clarity.

FIG. 30 is a perspective view of an alternative embodiment of a component of the actuation mechanism of FIG. 14.

FIG. 31 is a perspective view of another example of a component for use with an actuation mechanism.

FIG. 32 is a cross-sectional view of an actuation mechanism including the component of FIG. 31.

FIG. 33 is a cross-sectional view of the actuation mechanism of FIG. 32 in a second mode.

FIG. 34 is a perspective view of a further example of a component for use with an actuation mechanism.

FIG. 35 is a cross-sectional view of an actuation mechanism including the component of FIG. 34.

FIG. 36 is a schematic cross-sectional view of the actuation mechanism of FIG. 35 with portions removed for clarity.

FIGS. 37A and 37B are schematic views of a cam follower for use in the actuation mechanism of FIG. 35.

FIG. 38 is a perspective view of yet another example of a component for use with an actuation mechanism.

FIG. 39 is a perspective view of a cam follower for use with the component of FIG. 38.

FIG. 40 is a cross-sectional view of an actuation mechanism including the component of FIG. 38.

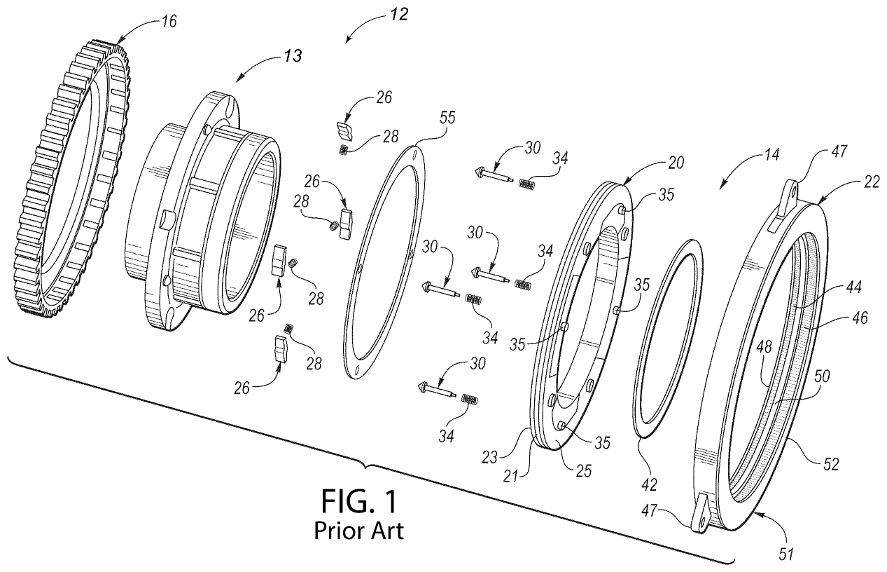

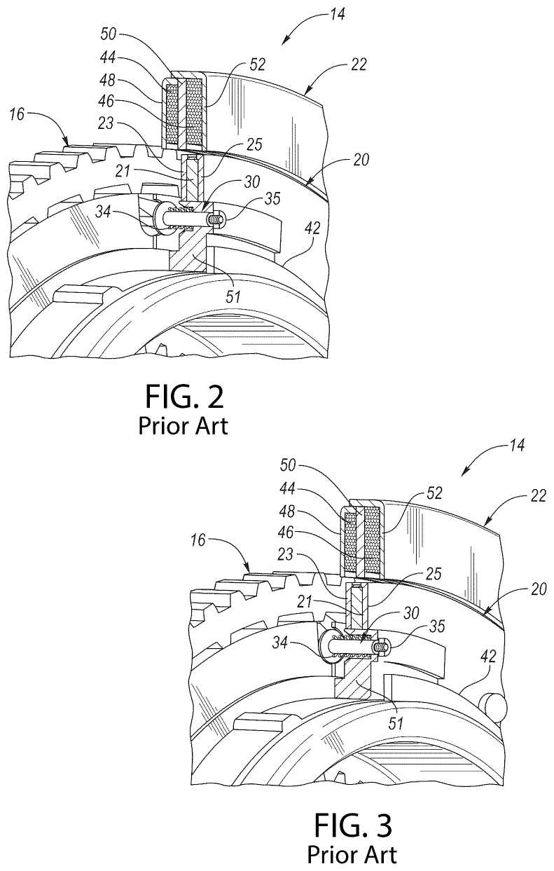

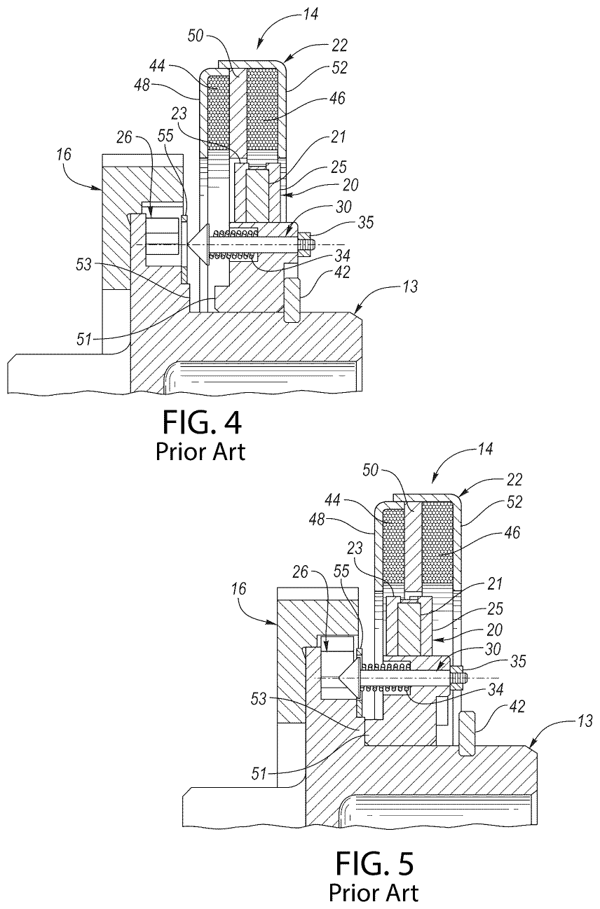

### DETAILED DESCRIPTION OF THE PREFERRED EMBODIMENTS

The following description of the preferred embodiment(s) is merely exemplary and is in no way intended to limit the invention, application, or use.

Examples of the present invention are disclosed herein; however, it is to be understood that the disclosed embodiments are merely exemplary of the invention that may be embodied in various and alternative forms. The figures are not necessarily to scale; some features may be exaggerated or minimized to show details of the components. Therefore, specific structural and functional details disclosed herein are not to be interpreted as limiting but merely as a representative basis for teaching one skilled in the art to variously employ the present invention.

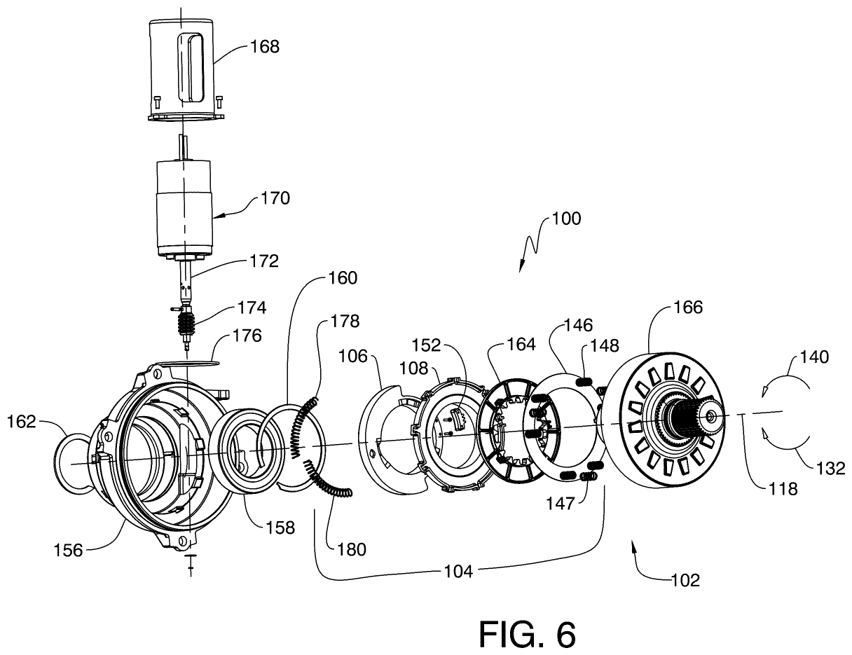

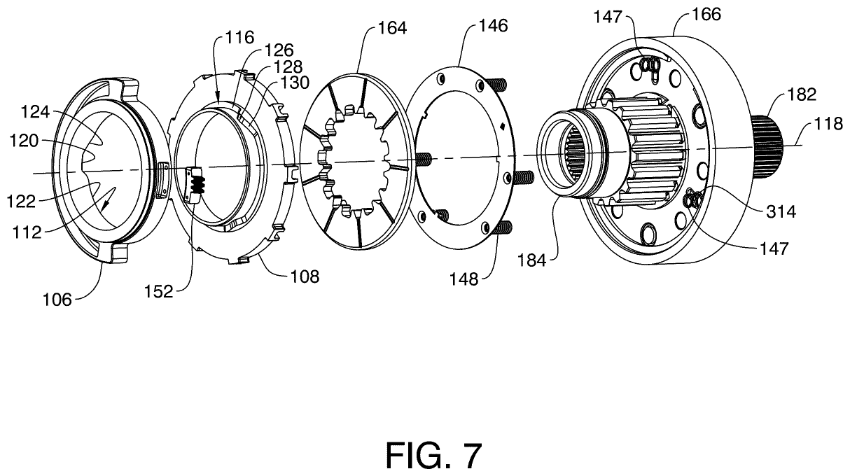

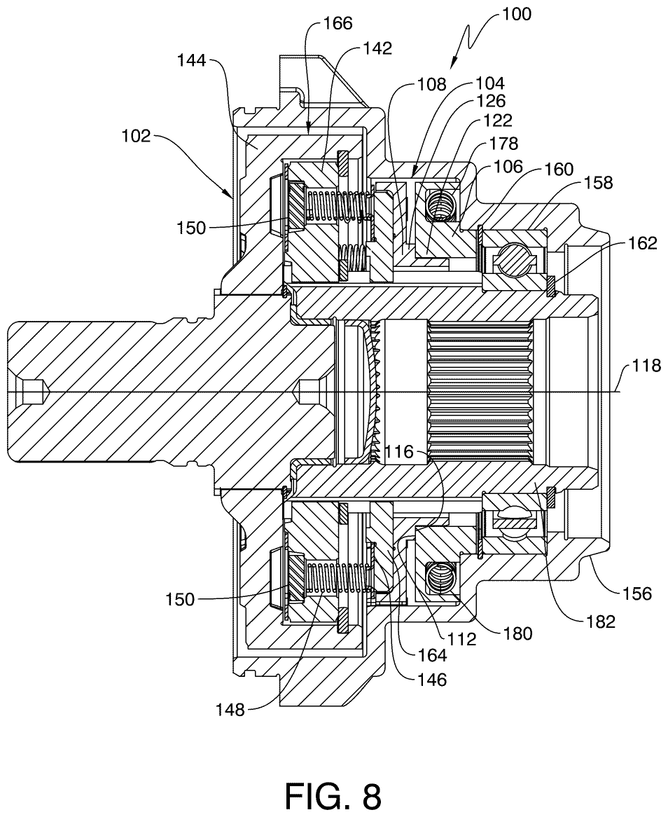

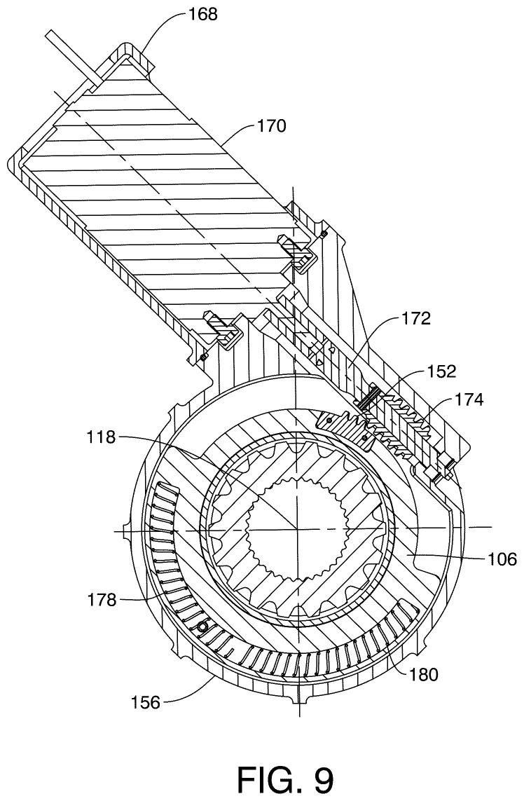

FIGS. 6-13 show one example of a system 100, including a clutch assembly 102 with a dynamically controllable clutch (DCC) 166 and a linear actuator 104. The dynamically controllable clutch (DCC) 166 typically includes a pocket plate 142, a notch plate 144, and a locking element 150, shown in FIG. 8. The pocket plate 142 connects to the first power component, for example a driveshaft 184, and the notch plate 144 connects to the second power component, for example a driven shaft 182. The linear actuator 104 includes a first cam member 106 and a second cam member 108. The linear actuator may also include a spring plate 146, having return springs 147 and actuation springs 148, and a thrust plate or bearing member 164. The actuation springs 148 of the spring plate 146 act on the locking elements 150, while the return springs 147 of the spring plate 146 contact the pocket plate 142 and bias the second cam member 108 axially toward the first cam member 106.

The clutch assembly 102 includes a clutch assembly housing 156, a bearing 158, and snap rings 160, 162. The first cam member 106 includes a gear sector 152. The system 100 also includes a motor housing 168 for a motor 170. The motor 170 includes a motor shaft 172, a worm 174, and an O-ring 176. The motor 170 is configured to actuate the first cam member 106 and cause the first cam member 106 to rotate about the rotational axis 118 in the directions shown by the arrows 132, 140.

The clutch assembly 102 includes biasing springs 178, 180 that maintain contact between the worm 174 and gear sector 152 of the first cam member 106. In another example, an electric or hydraulic mechanism may be used to rotate the first cam member 106.

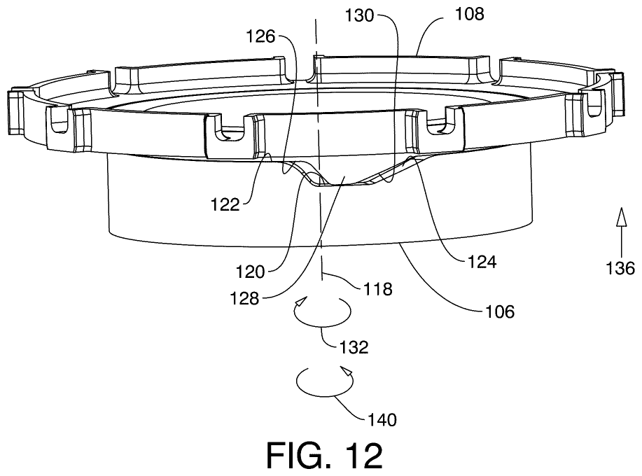

The linear actuator 104 moves between a first, initial position and a second, extended position. Placing the linear actuator 104 in the second, extended position moves the locking element 150 to a deployed position and couples the pocket plate 142 and notch plate 144. When the linear actuator 104 is in the second, extended position the second cam member 108, through the spring plate 146 and actuation springs 148, causes the locking element 150 to couple the pocket plate 142 and notch plate 144. When the linear actuator 104 is in the first, initial position, the return springs 147 push the first cam member 106 and second cam member 108 together, see FIGS. 8 and 12, wherein the actuation springs 148 do not act on the locking elements 150 and the pocket plate 142 and notch plate 144 of the dynamically controllable clutch (DCC) 166 are decoupled. Consequently, when the linear actuator 104 is in the second, extended position, torque flow between components fixedly connected to the pocket plate 142 and the notch plate 144 is enabled.

The linear actuator 104 includes a cam mechanism. A cam mechanism usually consists of two moving elements mounted on a fixed frame, a cam, and a cam follower. The cam follower moves in a plane transverse to the axis of rotation of the cam.

The first cam member 106 is a rotating portion of a cylinder, with a cam face or cam surface 112 being one end of the cylinder. The first cam member 106 functions as the “cam,” it is rotatably movable but axially fixed. The second cam member 108 is an axially moving portion of a cylinder, with a cam face or cam surface 116 being one end of the cylinder. The second cam member 108 functions as the “cam follower,” it is rotatably fixed but axially movable. The second cam member 108 translates, moves axially in the longitudinal direction of the rotational axis 118, whereas the cam or first cam member 106 rotates about the rotational axis 118.

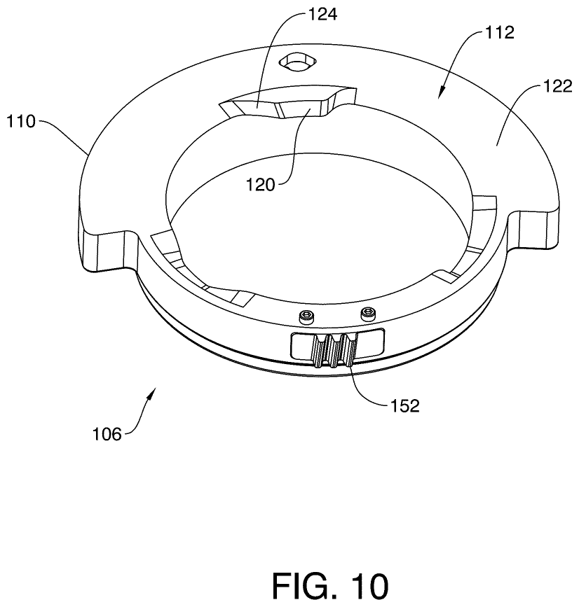

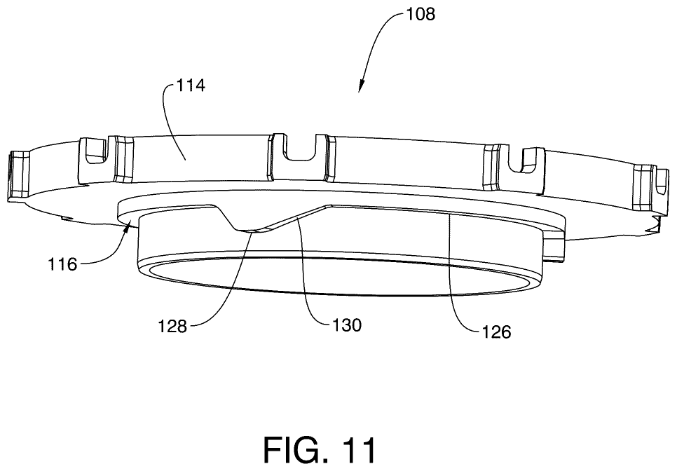

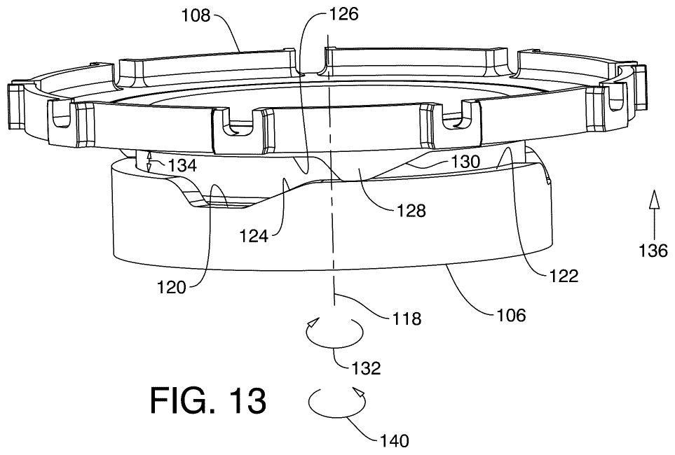

In one example, the linear actuator 104 functions as a two-position actuator. FIG. 10 shows the first cam member 106 with a cylindrical body 110 and a cam surface 112. The cam surface 112 includes a base surface 120, a projecting member or surface 122, and ramps 124 between the base surface 120 and the projecting member or surface 122. The projecting member or surface 122 extends or projects axially from the base surface 120. FIG. 11 shows the second cam member 108 with a cylindrical body 114 with a cam surface 116. The cam surface 116 includes a base surface 126, a projecting member or surface 128, and ramp 130 between the base surface 126 and the projecting member or surface 128. The projecting member or surface 128 extends or projects axially from the base surface 126. FIG. 12 shows the linear actuator 104 in a first, initial position. As shown, the projecting member or surface 128 of the second cam member 108 is positioned adjacent to the base surface 120 of the first cam member 106. FIG. 13 shows the linear actuator 104 in a second, extended position. As shown, the projecting member or surface 128 of the second cam member 108 is positioned adjacent to the projecting member or surface 122 of the first cam member 106.

To move the linear actuator 104 to the second, extended position, the first cam member 106 rotates in the direction of the arrow 132 about the rotational axis 118. The interaction between cam surface 112 of the first cam member 106 and cam surface 116 of the second cam member 108 causes the second cam member 108 to move axially away from the first cam member 106 in the direction of the arrow 136. The projecting member or surface 128 of the second cam member 108 moves up the ramp 124 of the first cam member 106 until it reaches and moves along the projecting member or surface 122 of the first cam member 106, wherein the second cam member 108 moves axially away from the first cam member 106 a distance illustrated by the arrow 134.

The linear actuator 104 may be used to control system components; for example, engagement when the actuator is in the second, extended position and disengagement when the actuator is in the first, initial position. To return or retract the linear actuator 104 to the first, initial position, the first cam member 106 rotates in an opposite or second direction, shown by the arrow 140. The interaction between cam surface 112 of the first cam member 106 and cam surface 116 of the second cam member 108 enables the second cam member 108 to move axially toward the first cam member 106. The second cam member 108 is externally biased by the return spring 147 to move axially toward the first cam member 106.

In one example, the linear actuator 104 actuates a clutch assembly 102 between a first mode in which first and second coupling members of the clutch assembly 102 are coupled together and a second mode in which the first and second coupling members are not coupled together. The linear actuator 104 includes a first cam member 106 and a second cam member 108. The first cam member 106 has a cam surface 112 rotatably movable and axially fixed, and the second cam member 108 has a cam surface 116 rotatably fixed and axially movable. The first cam member 106 and second cam member 108 are axially stacked together with the respective cam surfaces 112, 116 facing each other. Rotation of the first cam member 106 and interaction of the cam surfaces 112, 116 axially moves the second cam member 108 away from the first cam member 106, placing the linear actuator 104 in the second, extended position. Placing the linear actuator 104 in the second, extended position moves the locking element 150 in a deployed position correspondingly coupling together the coupling members, for example, the pocket plate 142 and the notch plate 144 of the dynamically controllable clutch (DCC) 166.

When the first cam member 106 rotates in the opposite direction, shown by the arrow 140, the interaction between the respective cam surfaces 112, 116 allows the spring force applied by the return springs 147 to move the second cam member 108 axially toward the first cam member 106 whereby the linear actuator 104 is in the first, initial position and the coupling members, the pocket plate 142 and the notch plate 144, are not coupled together.

The first and second coupling members, the pocket plate 142 and the notch plate 144, are supported for rotation relative to one another in first and second directions about a rotational axis. A locking element 150 moves between a deployed position, in which the locking element 150 mechanically couples the coupling members together to prevent relative rotation of the coupling members in at least one direction about the rotational axis, and a non-deployed position, in which the coupling members are not mechanically coupled together by the locking element 150 whereby the coupling members may rotate relative to one another in the first and second directions about the rotational axis.

Interaction of the cam surfaces 112, 116 caused by rotation of the first cam member 106 in the direction of the arrow 132 axially moves the second cam member 108 away from the first cam member 106, putting the linear actuator 104 in a second, extended position and moving the locking element 150 to a deployed position. Interaction of the cam surfaces 112, 116 caused by rotation of the first cam member 106 in the opposite direction, direction of the arrow 140, axially moves the second cam member 108 toward the first cam member 106, putting the linear actuator 104 in the first, initial position wherein the locking element 150 is placed in the non-deployed position.

One example of the system includes first and second power components, such as a driveshaft and a driven shaft. The clutch assembly 102 includes first and second coupling members, for example, a pocket plate 142 and a notch plate 144. The pocket plate 142 connects to the first power component, the driveshaft 184, and the notch plate 144 connects to the second power component, the driven shaft 182. The first and second coupling members are supported for rotation relative to one another in first and second directions about a rotational axis.

The clutch assembly 102 also includes a locking element 150 movable between a deployed position in which the locking element mechanically couples the coupling members together and a non-deployed position in which the coupling members, and correspondingly the power components are not mechanically coupled together.

A link or connecting element extends between the second cam member 108 and the locking element 150. One example of a link or connecting element is the actuation spring 148 supported by the spring plate 146. The link or connecting element transfers the axial movement of the second cam member 108 to the locking element 150. When the linear actuator is in the second, extended position, the link or connecting element actuates the locking element 150, moving it to the deployed position. Other examples of a link or connecting element include resilient members, rods, or shaped members.

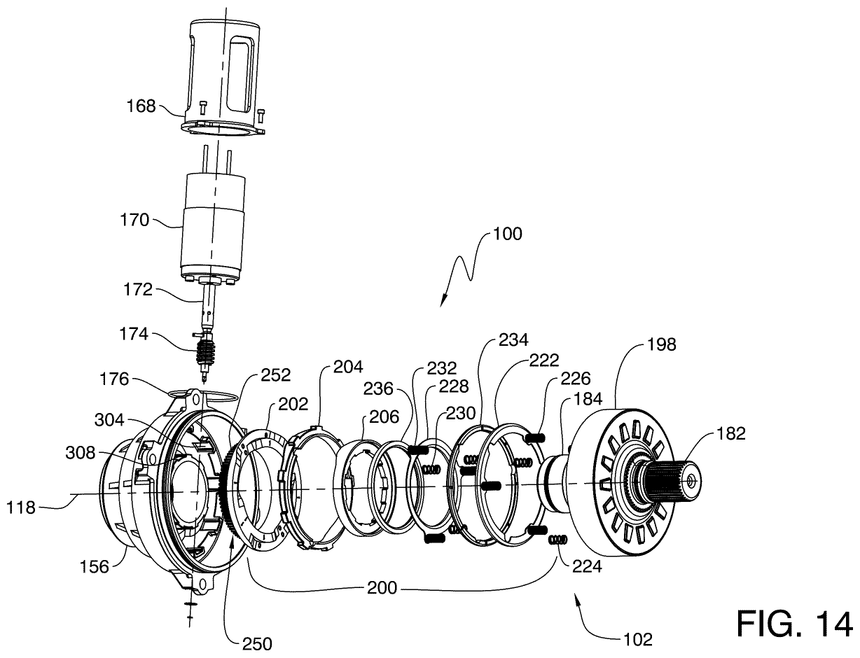

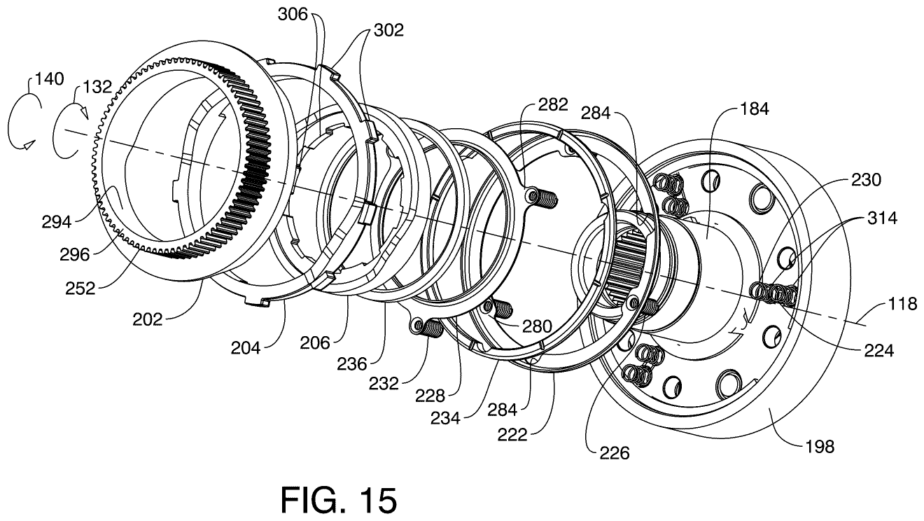

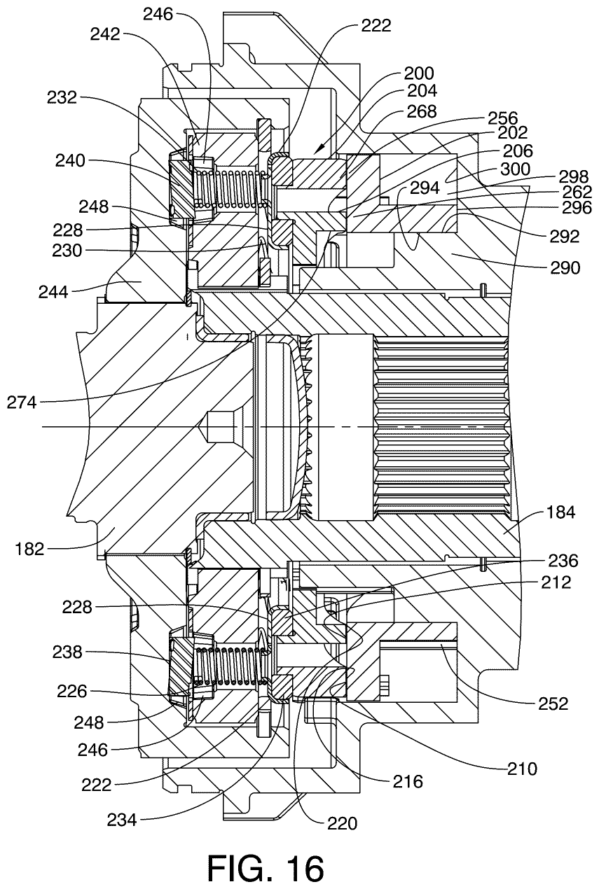

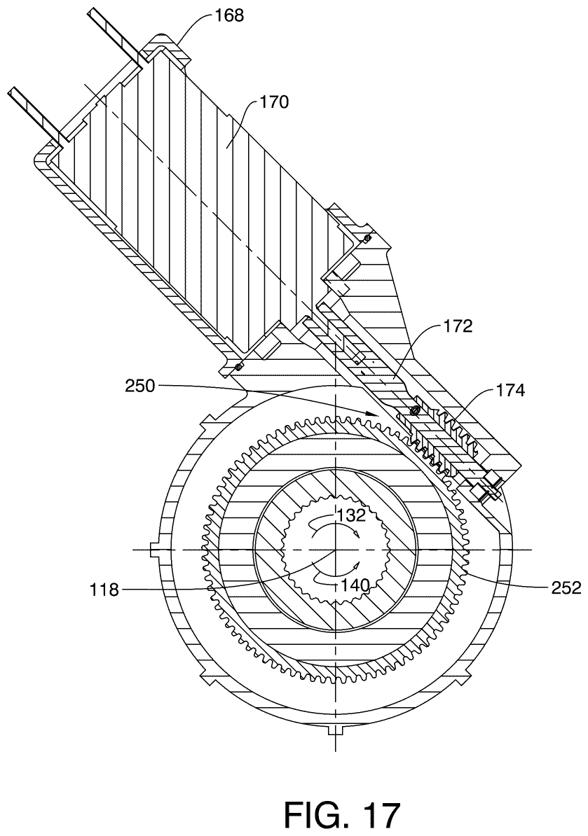

FIGS. 14-30 show an alternative example of the system, including a clutch assembly 102 with a dynamically controllable clutch (DCC) 198 and a linear actuator, generally indicated at 200. In each of the following embodiments, similar or identical elements are given consistent reference numerals throughout the various figures and indicate corresponding parts.

The dynamically controllable clutch (DCC) 198 typically includes a pocket plate 242, a notch plate 244, a first locking element 238, and a second locking element 240. In one example, the first and second locking elements 238, 240 are in pockets 246 in the pocket plate 242.

The linear actuator 200 includes a first cam member 202, a second cam member or cam follower 204, and a third cam member or cam follower 206. The linear actuator 200 may also include inner and outer actuation members, for example, a first or outer spring plate 222, having return springs 224 and actuation springs 226, and a second or inner spring plate 228 having return springs 230 and actuation springs 232. Positioned between the respective second cam member or cam follower 204 and third cam member or cam follower 206 and the first and second spring plates 222 and 228 are first and second thrust plates or bearing members 234, 236.

The dynamically controllable clutch (DCC) 198 provides a clutch assembly 102 that operates in four different modes, multiple connected states, or modes of torque transfer depending on how the first and second locking elements 238, 240 are positioned; for example, deployed, extended, engaged, or non-deployed, retracted, nonengaged. The linear actuator 200 works with the dynamically controllable clutch (DCC) 198 to impose torque in the counterclockwise and clockwise directions. The following nomenclature (__/__) refers to rotation direction, clockwise and counterclockwise, for the dynamically controllable clutch (DCC) 198, wherein the left side of the slash signifies torque imposition in the counterclockwise direction, and the right of the slash signifies torque imposition in the clockwise direction. As used herein, a numeral (1) on the left side of the slash indicates torque imposition in the counterclockwise direction. A numeral zero (0) on the left side of the slash indicates no torque imposition in the counterclockwise direction. The same convention, either a one (1), indicating torque imposition in the clockwise direction, or a zero (0), indicating no torque imposition in the clockwise direction, is used on the right side of the slash. The direction of torque imposition identifies a locked state or direction.

A first mode of the clutch assembly is configured as follows, dynamically controllable clutch (DCC) 198-0/0. In this mode, the first locking element 238 and second locking element 240 of the dynamically controlled clutch (DCC) 198 are not deployed and are nonengaged. The first coupling or pocket plate 242 transmits no torque either clockwise or counterclockwise. Neither the first locking element 238 nor the second locking element 240 engages the second coupling or notch plate 244, and the pocket plate 242 transmits no torque in either direction to the notch plate 244. The notch plate 244 is free to rotate in both counterclockwise and clockwise directions with respect to the pocket plate 242.

A second mode of the clutch assembly is configured as follows, dynamically controllable clutch (DCC) 198-1/0. In this mode, the first locking element 238 of the dynamically controllable clutch (DCC) 198 is engaged. The second locking element 240 of the dynamically controllable clutch (DCC) 198 is nonengaged, wherein the pocket plate 242 transmits torque in one direction, for example, in the counterclockwise direction to the notch plate 244, overruns the notch plate 244 in the clockwise direction, and the notch plate 244 overruns the pocket plate 242 in the counterclockwise direction when the speed of rotation ω₂₄₄ of the driven member, notch plate 244, in the counterclockwise direction is faster than the rotational speed ω₂₄₂ of the driving member, pocket plate 242 in the counterclockwise direction.

A third mode of the clutch assembly is configured as follows, dynamically controllable clutch (DCC) 198-0/1. In this mode, the first locking element 238 of the dynamically controllable clutch (DCC) 198 is nonengaged. The second locking element 240 of the dynamically controllable clutch (DCC) 198 is engaged wherein the pocket plate 242 transmits torque in one direction, for example, the clockwise direction, to the notch plate 244, overruns the notch plate 244 in the opposite or counterclockwise direction, and the notch plate 244 overruns the pocket plate 242 in the clockwise direction when the speed of rotation ω₂₄₄ of the driven member, notch plate 244, in the clockwise direction is faster than the rotational speed ω₂₄₂ of the driving member, pocket plate 242 in the clockwise direction.

A fourth mode of the clutch assembly is configured as follows, dynamically controllable clutch (DCC) 198-1/1. In this mode, the locking elements 238, 240 of the dynamically controllable clutch (DCC) 198 are both engaged, wherein the pocket plate 242 transmits torque in both the counterclockwise and clockwise directions to the notch plate 244, and the notch plate 244 rotates with the pocket plate 242 in both directions.

The clutch assembly 102 of the system 100 further includes a clutch assembly housing 156. The system 100 also includes a motor housing 168 for a motor 170. The motor 170 includes a motor shaft 172, a worm 174, and an O-ring 176. A gear assembly, seen generally at 250, operates to rotate the first cam member 202. The gear assembly 250 includes a plurality of gear teeth, for example, a ring gear 252 on an outer peripheral surface of the first cam member 202. The ring gear 252 engages the worm 174, whereby rotation of the motor 170 in either direction translates into rotational movement of the first cam member 202 about the rotational axis 118. The motor 170 actuates the first cam member 202 of the linear actuator 200, causing the first cam member 202 to rotate about the rotational axis 118, in the directions shown by the arrows 132, 140. The linear actuator 200 actuates the dynamically controllable clutch 198 through all four modes. The first cam member 202 functions as the “cam,” it is rotatably movable but axially fixed. The second and third cam members 204, 206 function as “cam followers,” they are rotatably fixed but axially movable.

The clutch assembly housing 156 includes an axially extending spindle 290 that rotatably supports the first cam member 202 in an annular aperture or recess 298. An outer peripheral surface 292 of the spindle 290 engages and supports an inner peripheral surface 294 of the first cam member 202, wherein the first cam member 202 rotates about the spindle 290. An end face 296 of the first cam member 202 engages a shoulder or bearing face 300 of the annular aperture or recess 298 and limits axial movement of first cam member 202. The return springs 224, 230, supported in sockets or seats 314 in the pocket plate 242, act through the respective first and second spring plates 222, 228 and first and second thrust plates or bearing members 234, 236 on the second cam member or cam follower and third cam member or cam follower 204, 206 to push or bias the end or face 296 of the first cam member 202 against the shoulder or bearing face 300 of the clutch assembly housing 156. While the first cam member 202 rotates, it is constrained against axial motion.

The second cam member or cam follower 204 includes a plurality of outwardly extending projections, for example, ribs or ridges 302 that engage complementary grooves 304 in the clutch assembly housing 156. The ribs or ridges 302 and complementary grooves 304 allow the second cam member or cam follower 204 to move axially but not rotationally. The ribs or ridges 302 slide axially in the grooves 304. The third cam member or follower 206 includes a plurality of inwardly extending projections, for example, ribs or ridges 306 that engage complementary grooves 308 on the spindle 290. The ribs or ridges 306 and complementary grooves 308 allow the third cam member or follower 206 to move axially but not rotationally. The first and second thrust plates or bearing members 234, 236 provide a rotational interface and support between the respective second and third cam members or cam followers 204, 206, and the first and second spring plates 222, 228.

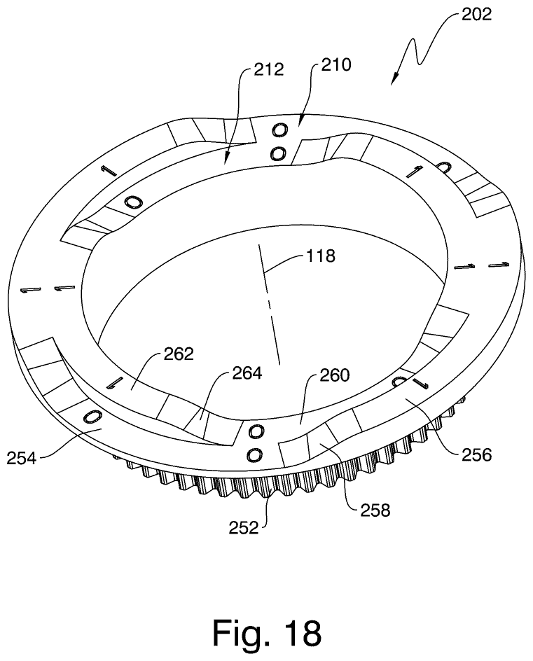

Referring to FIG. 18, the cam profiles of the first cam surface 210 and the second cam surface 212 of the first cam member 202 may have a “wave” shape, pattern, or configuration. The first cam surface 210 may include a base surface 254, a projecting member or surface 256, and ramps 258 extending between the base surface 254 and the projecting member or surface 256. The second cam surface 212 may include a base surface 260, a projecting member or surface 262, and ramps 264 extending between the base surface 260 and the projecting member or surface 262.

The cam or first cam member 202 is a rotating portion of a cylinder with the cam surfaces 210, 212 being on one end of the cylinder. The first cam surface 210 and the second cam surface 212 are concentric circular surfaces on one end of the cylindrical body of the first cam member 202. FIG. 18 shows the respective cam profile or configuration of each of the first and second cam surfaces 210, 212 associated with each mode or position of the dynamically controllable clutch (DCC) 198. As shown, each of the four positions is identified by the nomenclature 1/1, 0/1, 1/0, and 0/0 on the first cam member 202. When the second and third cam members or cam followers 204, 206 are positioned at the respective identified positions, the dynamically controllable clutch 198 is placed in the corresponding mode.

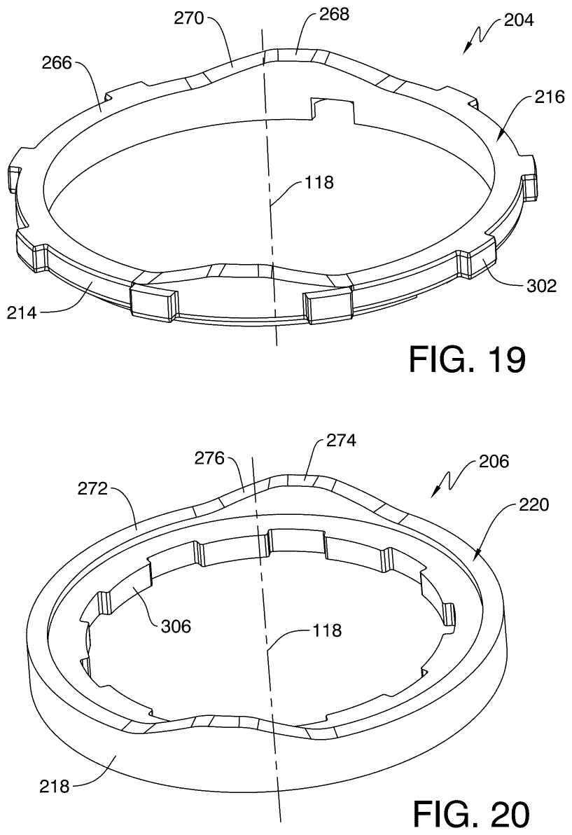

Referring to FIG. 19, the second cam member or cam follower 204 has a cylindrical body 214 with a cam profile, cam face or cam surface 216, on one end of the cylindrical body 214. The cam face or surface 216 of the second cam member or cam follower 204 may have a “wave” shape, pattern, or configuration. The cam surface 216 may include a base surface 266, a projecting member or surface 268, and ramps 270 extending between the base surface 266 and the projecting member or surface 268. The cam face or surface 216 of the second cam member or cam follower 204 engages and follows the first cam surface 210.

Referring to FIG. 20, the third cam member or cam follower 206 has a cylindrical body 218 with a cam profile, cam face or cam surface 220, on one end of the cylindrical body 218. The cam face or surface 220 of the third cam member or cam follower 206 may have a “wave” shape, pattern, or configuration. The cam surface 220 may include a base surface 272, a projecting member or surface 274, and ramps 276 extending between the base surface 272 and the projecting member or surface 274. The cam face or surface 220 of the third cam member or cam follower 206 engages and follows the second cam surface 212.

The first cam surface 210 and second cam surface 212 of the first cam member 202 are concentric surfaces. The first cam surface 210 of the first cam member 202 is axially stacked with the cam surface 216 of the second cam or cam follower 204, and the second cam surface 212 of the first cam member 202 is axially stacked together with the cam surface 220 of the third cam 206. Accordingly, the second cam or cam follower 204 and the third cam or cam follower 206 also have concentric cylindrical surfaces, with one of the surfaces inside the other. The second cam member or cam follower 204 and the third cam member or follower 206 move independently along the respective first and second cam surfaces 210, 212 of the first cam member 202 as the first cam member 202 rotates. Rotation of the first cam member 202 and interaction of the respective cam surfaces 210, 216, 212, 220 axially moves the second and third cams or cam followers 204, 206 away from and toward the first cam member 202. Moving the respective second and third cams or cam followers 204, 206 places the linear actuator 200 in multiple positions.

The first cam member 202 has discreet positions, 0/0, 0/1, 1/0, and 1/1. The motor 170, through the gear assembly 250, rotates the first cam member 202 in either direction, shown by arrows 132, 140, to position the first cam member 202 in one of the positions, 0/0, 1/0, 0/1 and 1/1. Depending upon the selected position, interaction between the cam surfaces of the respective cam members 202, 204, 206, the second cam member or cam follower 204 moves between an extended, locking element deployed position and an initial or retracted, locking element non-deployed position, while the third cam member or follower 206 moves between an extended, locking element deployed position and an initial or retracted, locking element non-deployed position. Based on the combination of the deployed and non-deployed positions, the first and second locking elements 238, 240 mechanically couple the coupling members together.

In one example, the linear actuator 200 is a four-position actuator. The linear actuator 200 starts at the 0/0 mode and based on rotation and direction of the first cam member 202, other modes or positions are achieved. The linear actuator 200 may also start at one of the other modes, for example the 1/1 mode. In addition, rather than modes 1/0 or 0/1 being adjacent to mode 0/0, mode 1/1 could be adjacent to mode 0/0.

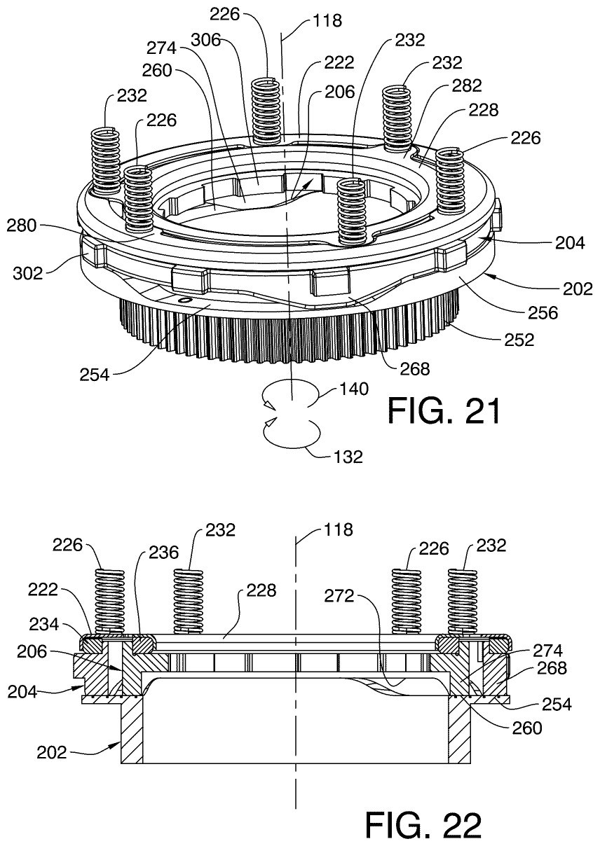

FIGS. 21, 22 show the linear actuator 200 in a 0/0 mode, with the second cam member or cam follower 204 and the third cam member or follower 206 in an initial or retracted position. The return springs 224, 230, which bias or urge the cam second and third cam members or cam followers 204, 206 and first cam member 202 together, are removed for clarity, with the actuation springs 226, 232 shown. In the first or initial position, the 0/0 mode, the first and second locking elements 238, 240 are in the non-deployed position, as both cam followers 204 and 206 of the linear actuator 200 are in the initial or retracted position. As illustrated in FIG. 22, in the initial or retracted position, the projecting members or surfaces 268, 274 of each of the second cam member or cam follower 204 and third cam member or follower 206 are located at the base 254, 260, of each of the first and second cam surfaces 210, 212. The actuation springs 226, 232 are in an initial, retracted position where they do not act on and deploy the locking elements 238, 240.

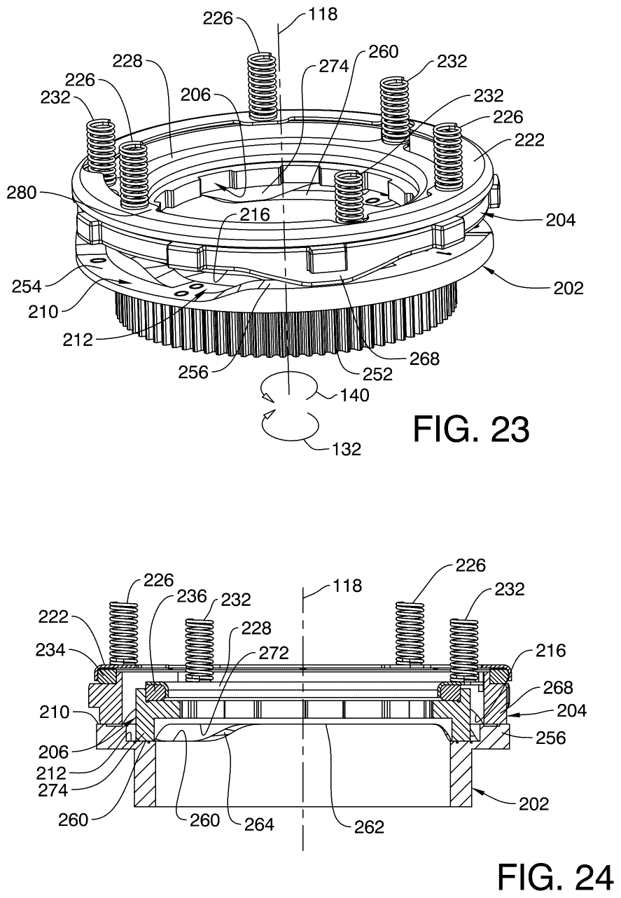

FIGS. 23, 24 illustrate the linear actuator 200 in a 1/0 mode. The second cam member or cam follower 204, the outer concentric ring, is positioned in an extended position. To achieve the 1/0 mode, the first cam member 202 is rotated clockwise, in the direction of the arrow 132, until the first projecting member or surface 256 of the first cam surface 210 of the first cam member 202 is adjacent or contacts the projecting member or surface 268 of the second of the cam surface 216 of the second cam or cam follower 204 thereby extending or moving the second cam or cam follower 204 axially with respect to the first cam member 202. Moving the second cam or cam follower 204 axially moves the first thrust plate or bearing member 234, the first spring plate 222, and actuation spring 226 axially, wherein the actuation spring 226 acts on the first locking element 238, placing it in a deployed position. Rotating the first cam member 202 in the clockwise direction, arrow 132, moves the linear actuator 200 from the 0/0 mode to the 1/0 mode. When rotating the first cam member 202 in the clockwise direction, shown by the arrow 132, the projecting member or surface 274 of the third cam member or follower 206, inner concentric ring, follows along the second cam surface 212 and remains on the base 260. The actuation spring 232 of the second spring plate 228 remains in the initial, retracted position where it does not act on and deploy the locking element 240.

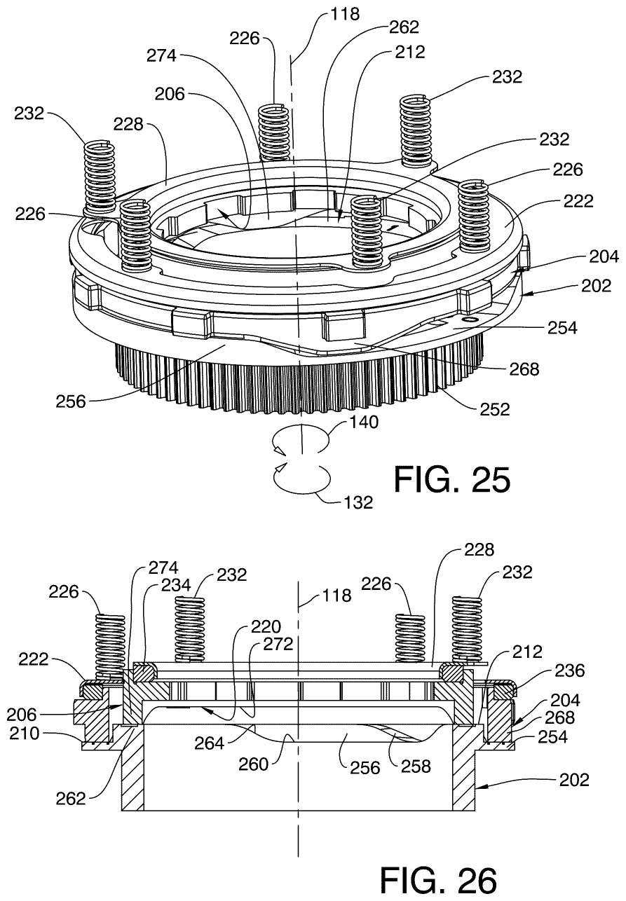

FIGS. 25, 26 illustrate the linear actuator 200 in a 0/1 mode. The third cam member or follower 206, the inner concentric ring, is positioned in an extended position. To achieve the 0/1 mode, the first cam member 202 rotates counterclockwise in the direction of the arrow 140, from the 0/0 mode until the projecting member or surface 262 of the second cam surface 212 of the first cam member 202 is adjacent or contacts the projecting member or surface 274 of the cam surface 220 of the third cam or cam follower 206 extending or moving the third cam or cam follower 206 axially with respect to the first cam member 202. In this position, the projecting member or surface 274 of the cam surface 220 of the third cam or cam follower 206 is adjacent or placed on the projecting member or surface 262 of the second cam surface 212 of the first cam member 202. Moving the third cam or cam follower 206 axially moves, through the second thrust plate or bearing member 236, the second spring plate 228 and actuation spring 232 in the axial direction wherein the actuation spring 232 acts on the second locking element 240 moving it to a deployed position. Rotating the first cam member 202 in the counterclockwise direction, arrow 140, moves the linear actuator 200 from the 0/0 mode to the 0/1 mode. When rotating the first cam member 202 in the counterclockwise direction, the projecting member or surface 268 of the second cam member or cam follower 204, outer concentric ring, follows the second cam surface 212 and remains on the base 254. The actuation spring 232 of the second spring plate 228 is in the initial or retracted position where it does not act on or deploy the locking element 238.

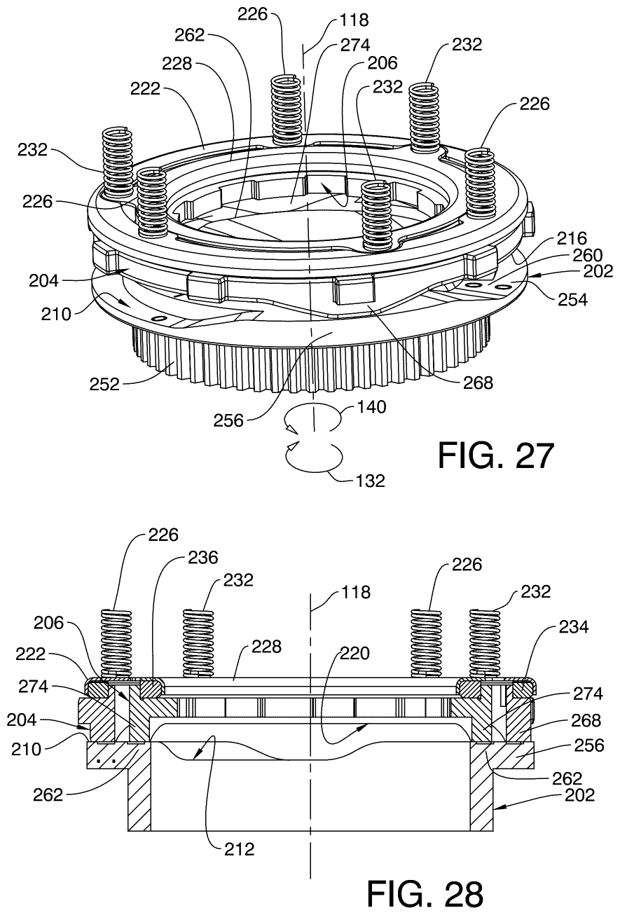

FIGS. 27, 28 illustrate the linear actuator 200 in a 1/1 mode. The second cam member or cam follower 204 and the third cam member or follower 206, the outer and inner concentric rings, are positioned in the extended position. To achieve the 1/1 mode, the first cam member 202 rotates either clockwise or counterclockwise from the 0/0 mode, through either the 1/0 or 0/1 modes until the first projecting member or surface 256 of the first cam surface 210 of the first cam member 202 is adjacent or contacts the projecting member or surface 268 of the second cam surface 216 of the second cam or cam follower 204 extending or moving the second cam or cam follower 204 axially with respect to the first cam member 202 and the projecting member or surface 262 of the second cam surface 212 of the first cam member 202 is adjacent or contacts the projecting member or surface 274 of the cam surface 220 of the third cam or cam follower 206 extending or moving the third cam or cam follower 206 axially with respect to the first cam member 202.

Moving the second cam or cam follower 204 axially correspondingly moves, through the first thrust plate or bearing member 234, the first spring plate 222 and actuation spring 226 in the axial direction wherein the actuation spring 226 acts on the first locking element 238, moving it to a deployed position. Moving the third cam or cam follower 206 axially correspondingly moves, through the second thrust plate or bearing member 236, the second spring plate 228 and actuation spring 232 in the axial direction wherein the actuation spring 232 acts on the second locking element 240 moving it to a deployed position. With both the first and second locking elements 238, 240 in a deployed position, the first coupling member or pocket plate 242 is coupled in both directions to the second coupling member or notch plate 244 by the locking elements 238, 240 extending from pockets 246 in the pocket plate and engaging notches 248 in the notch plate 244. Because the first coupling member or pocket plate 242 and second coupling member or notch plate 244 are connected to respective power components, for example, a driveshaft 184 and a driven shaft 182, coupling the pocket plate 242 to the notch plate 244 couples the driveshaft 184 and driven shaft 182 enabling power or torque transfer from the drive shaft to the driven shaft.

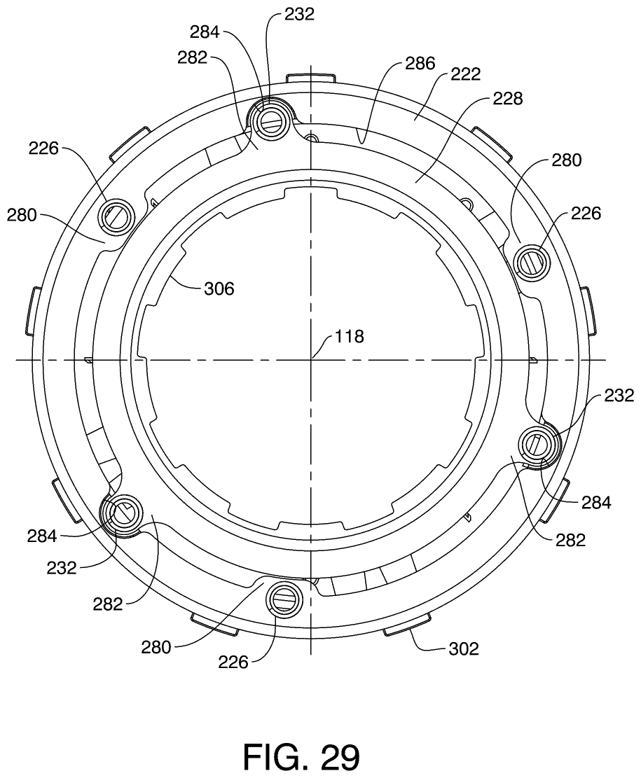

FIG. 29 shows an outer actuation member for example, the first spring plate 222, having an annular configuration, and an inner actuation member for example, the second spring plate 228 having an annular configuration. The outer actuation member is concentric with the inner actuation member. While the respective first spring plate 222 and second spring plate 228 are inner and outer members spaced from one another, the actuation springs 226 and 232 are on the same radius, the same radial distance from the rotational axis 118. As illustrated, the first spring plate 222 includes inwardly extending tabs 280. The second spring plate 228 includes outwardly extending tabs 282 that extend into complementary notches 284 located in the inner circumferential surface 286 of the first spring plate 222. The respective inwardly extending tabs 280 and outwardly extending tabs 282 provide spring seats for the respective actuation springs 226 and 232.

The actuation spring 226 operates as link element connecting or linking the second cam member or cam follower 204 with one of the first and second locking elements 238, 240 and the actuation spring 232 operates as a link element connecting or linking the third cam member or cam follower 206 with the other of the first and second locking elements 238, 240. In addition, the first and second spring plates 222, 228 may also operate as link elements. These are but one example of link elements that may be used to connect or link the second and third cam members or cam followers 204, 206 with the first and second locking elements 238, 240. Other examples of a link or connecting element include resilient members, rods, or shaped members that transfer the axial motion of the second and third cam members or cam followers 204, 206 to the respective first and second locking elements 238, 240 to control the position of the first and second locking elements 238, 240. In some instances, the axial motion produced by the linear actuator 200 may be used to move one of the locking elements 238, 240 from a deployed to a non-deployed position.

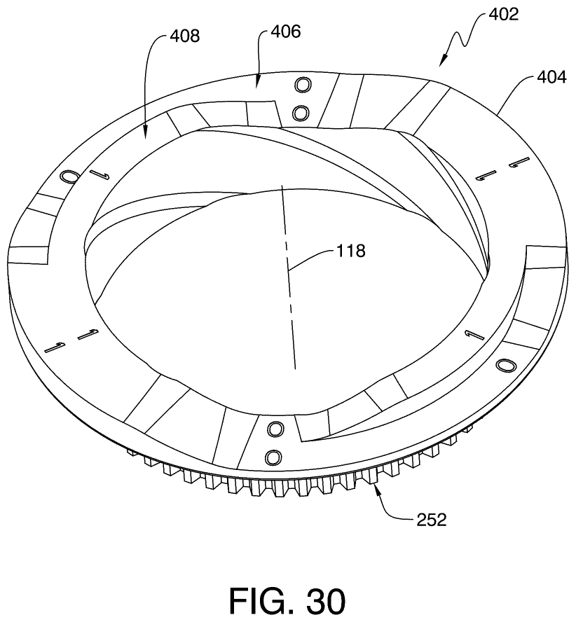

FIG. 30 discloses another alternative embodiment of the linear actuator 200, wherein the linear actuator 200 is a three-position actuator. The three positions are 0/0, 1/1, and 1/0. Like the four-position actuator, the three-position actuator 402 uses a first cam member 404 having a first cam surface 406 and a second cam surface 408. The cam surfaces 406, 408 of the three-position actuator 402 include projections and bases. Like the previous embodiment, a second cam or cam follower and a third cam or cam follower cooperate with the first cam member 404 to move the first and second coupling members between a deployed and non-deployed position. The three-position actuator 402 may be placed initially in the 1/0 mode, wherein rotation in either direction places the actuator 402 in either the 0/0 mode or the 1/1 mode. The 1/0 mode could be used to actuate a locking element to transfer torque in either the clockwise or counterclockwise direction.

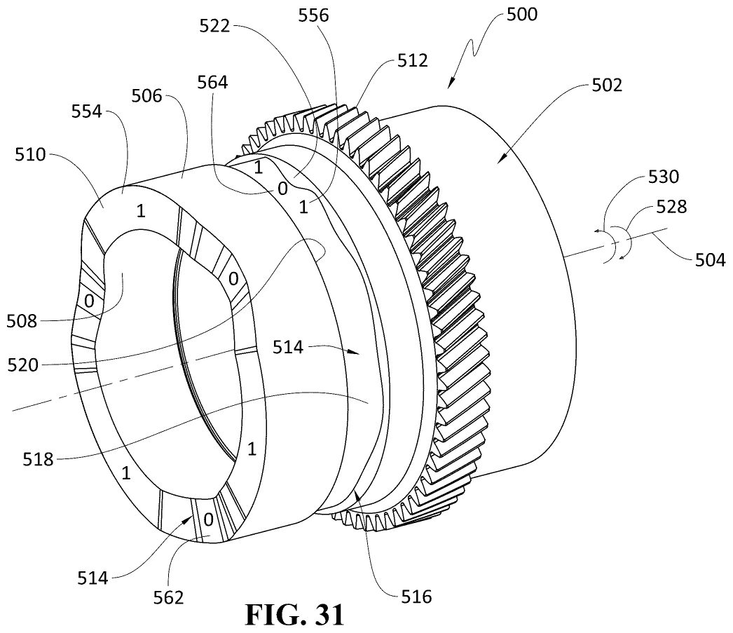

FIGS. 31-33 illustrate another example of a cam member, seen generally at 500, for use with an actuator. The cam member 500 has a cylindrically shaped body 502 extending along a longitudinal axis 504. The cylindrically shaped body 502 includes an outer peripheral surface 506 and an inner peripheral surface 508. The cylindrically shaped body 502 includes an end surface 510 extending between the outer peripheral surface 506 and the inner peripheral surface 508. A plurality of gear teeth 512, for example, a ring gear, are located on the outer peripheral surface 506. The gear teeth 512 engage another gear member, for example, a worm gear, wherein the worm gear operates in conjunction with the gear teeth 512 to rotate the cam member 500 about the longitudinal axis 504 in either direction, shown by arrows 528, 530.

The cam member 500 includes a first cam surface 514 on the end surface 510 and a second cam surface 516 on the outer peripheral surface 508. The first cam surface 514, is a longitudinal cam surface, wherein the cam surface varies in the longitudinal or axial direction, the direction of the longitudinal axis 504. The second cam surface 516, is a radial cam surface, wherein the cam surface varies in the radial direction, a direction transverse to the direction of the longitudinal axis 504. In the example of FIG. 31, the second cam surface 516 is formed by a base or lower surface 518, extending between first and second sidewalls 520, 522, of a circumferential groove or notch 524 in the outer peripheral surface 508.

Similar to the foregoing examples, both the first and second cam surfaces 514, 516 of the cam member 500 have discreet positions identified as 0 and 1. The motor, through the gear teeth 512, rotates the first cam member 500 in either direction, shown by arrows 528, 530, to position the first cam member 500 in one of the positions, 0/0, 1/0, 0/1 and 1/1. Depending upon the selected position, the interaction between the cam surfaces 514, 516 of the cam member 500, a first cam follower 532, associated with the first cam surface 514, and a second cam follower 534, associated with the second cam surface 516, causes the respective locking elements 542, 548 to move between an initial or retracted, locking element non-deployed position and an extended, locking element deployed positions. Based on the combination of the deployed and non-deployed positions, the first and second locking elements 542, 548 mechanically couple the coupling members together, for example, notch plates 550, 551 and a pocket plate 552. In one example, the pocket plate 552 connects to the first power component, for example, a driveshaft 558, and the notch plate 550 connects to the second power component, for example, a driven shaft 560. The pocket plate also connects the first power component, the driveshaft 558, to a stationary member or housing 551. The first and second locking elements 542, 548 part of a controllable clutch assembly used to couple different members. Including, in one example, a rotary member to a rotary member and/or a rotary member to a stationary member. In addition, while shown with a single locking elements 542, 548 multiple locking elements can be used. The multiple locking elements may also include locking elements acting in both directions of rotation. For example, two longitudinal locking elements controlled by the first cam surface 514. The two locking elements acting couple the members in either direction, shown by arrows 528, 530. In addition, there may be two radial locking elements controlled by the second cam surface. Again, radial locking elements acting couple the members in either direction, shown by arrows 528, 530.

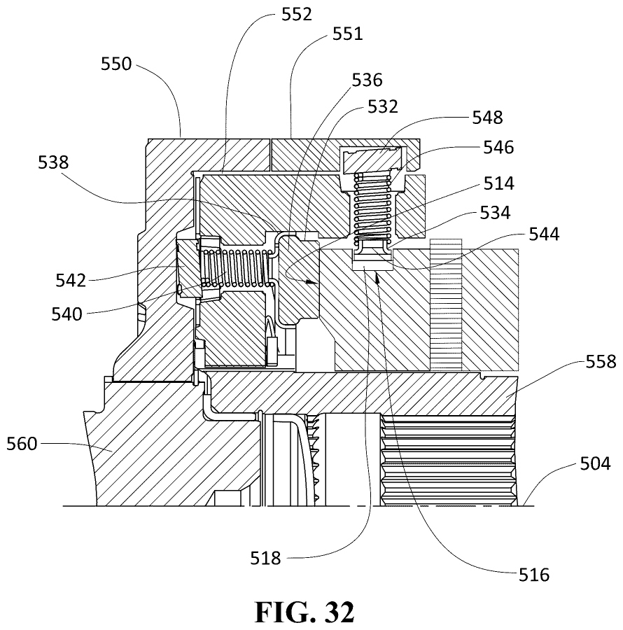

As shown in FIG. 32, the cam member 500 acts on the first cam follower 532. The first cam follower 532 includes a thrust plate or portion 536, engaging a spring plate 538. An actuation member, for example, an actuation spring 540, extends between the spring plate and the locking element 542.

The cam member 500 also acts on the second cam follower 534. The second cam follower 534 includes a tappet 544, for example, a lever or member, engaging the second cam surface 516. The tappet 544 acts on an actuation member, for example, an actuation spring 546, extending between the tappet 544 and the locking element 548.

Depending upon the position of the cam member 500, interaction between the cam surfaces 514, 516 and the respective cam followers 532, 534 move the locking elements 542, 548 between an extended, locking element deployed position and an initial or retracted, locking element non-deployed position.

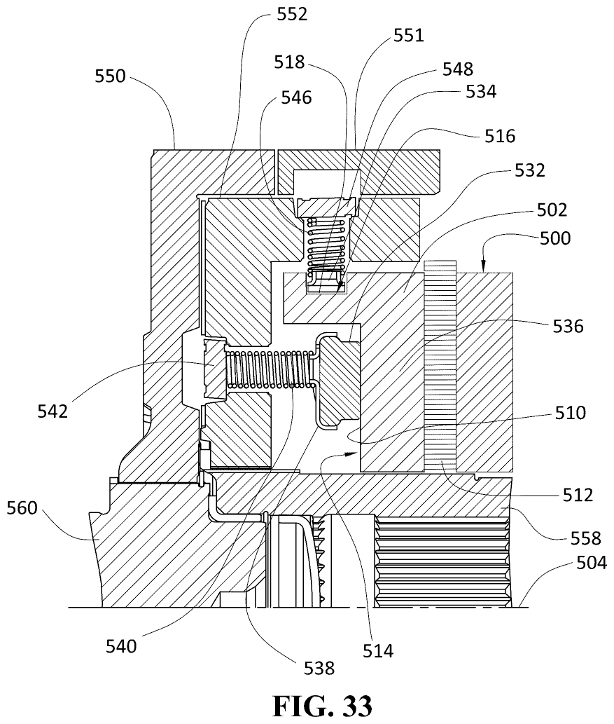

As illustrated in FIGS. 32 and 33, the first locking element 542 moves in an axial direction, in the direction of the longitudinal axis 504, and the second locking element 548 moves in a radial direction, a direction transverse to the longitudinal axis 504.

Similar to the previous embodiments, the axially moving locking element 542 and the radially moving locking element 548 are independently controlled to place the actuator in multiple modes. FIG. 32 illustrates the linear actuator in a 1/1 mode wherein the cam member 500 is rotated to a position such that each of the locking elements 542, 548 are placed in an extended locking element deployed position. A projection or projecting surface 554 on the first cam surface 514, associated with mode 1, contacts the thrust plate or portion 536 of the first cam follower 532 and extends or moves the first cam follower 532 and thrust plate or portion 536, the spring plate 538, the actuation spring 540 longitudinally, wherein the actuation spring 540 acts on the first locking element 542 placing it in a deployed position. The cam follower 532 may have a complementary configuration, for example, a corresponding projection or projecting surface, wherein when the two coincide and are opposed to one another they move the first cam follower 532. Similar to the first cam surface 514, the second cam surface 516 includes a projection or projecting surface 556 associated with mode 1. The projection or projecting surface 556 of the second cam surface 516 contacts the tappet 544 and extends or moves the tappet 544 radially outward, wherein the actuation spring 546 acts on the second locking element 548 and places it in a deployed position.

FIG. 33 illustrates the actuator in a 0/0 mode with the first and second cam followers 532, 534 in an initial or retracted position. In the 0/0 mode, the cam member 500 is rotated to a position such that the locking elements 542, 548 are placed in a retracted, nondeployed position. The thrust plate or portion 536 of the first cam follower 532 contacts a valley or depression 562, associated with mode 0, of the first cam surface 514. The tappet 544 of the second cam follower 534 contacts a valley or depression 564, associated with mode 0, of the second cam surface 516. When the actuator is in a 0/0 mode, the cam followers 532, 534 fit in respective valleys or depressions 562, 564 the first and second cam surfaces 514, 516.

The actuator may also include return springs. The return springs bias the first and second cam followers toward the first and second cam surfaces 514, 516. The return springs may act directly on the first and second cam followers 532, 534. They may also act through the first and second locking elements 542, 548. For example, the return springs act on the respective locking elements to bias or urge the locking elements to a nondeployed position. As illustrated, in the 0/0 mode, the first and second locking elements 542, 548 are in the non-deployed position as both the first and second cam followers 532, 534 are in the initial or retracted position. As illustrated, the surfaces of the first and second cam followers 532, 534 are located at the valley or depression 630, 640 of each of the first and second cam surfaces 514, 516. The actuation springs 540, 546 are in an initial, retracted position where they do not act on and deploy the locking elements 542, 548.

Similar to previous examples, the cam member 500 may place the actuator in a 1/0 mode wherein only the first locking element 532, associated with the axial or first cam surface 514, is deployed or in a 0/1 mode and wherein only the second locking element 548, associated with the second or radial cam surface 516 is deployed. The 1 and 0 mode numbers are illustrated on the respective first and second cam surfaces 514, 516 as examples of respective cam modes and are not required for actuator operation.

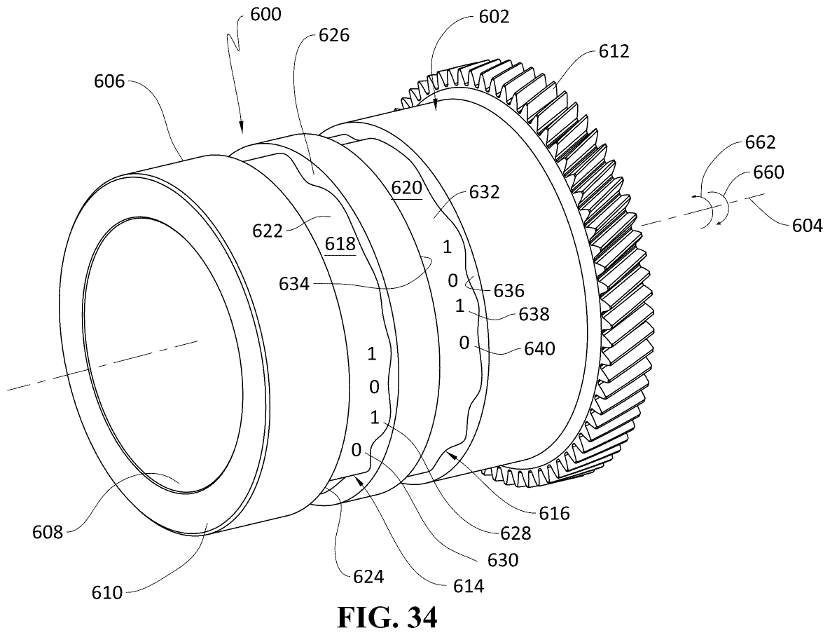

FIGS. 34-37B illustrate another example of a cam member 600 for use with an actuator operative to move locking elements between a first deployed position and a second nondeployed position. Similar to the previous embodiment, the cam member 600 has a cylindrically shaped body 602 extending along a longitudinal axis 604. The cylindrically shaped body 602 includes an outer peripheral surface 606 and an inner peripheral surface 608. The cylindrically shaped body 602 includes an end surface 610 extending between the outer peripheral surface 606 and the inner peripheral surface 608. A plurality of gear teeth 612, for example, a ring gear, are located on the outer peripheral surface 606. The gear teeth 612 engages another gear member, for example, a worm gear, wherein the worm gear operates in conjunction with the gear teeth 612 to rotate the cam member 600 about the longitudinal axis 604 in either a first direction 660 or a second direction 662.

The cam member 600 includes a first cam surface 614 and a second cam surface 616 on the outer peripheral surface 608. The first and second cam surfaces 614, 616 are radial cam surfaces. The cam surfaces vary in the radial direction, the direction transverse to the direction of the longitudinal axis 604. For example, the first and second cam surfaces 614, 616 are formed by first and second circumferential grooves or notches 618, 620 extending about the outer peripheral surface 608. The first groove or notch 618 includes a base or lower surface 622 extending between first and second sidewalls 624, 626. The base or lower surface 622 forms the first cam surface 614. The first cam surface 614 radially undulates. It includes radial projections or projecting surfaces 628 and valleys or depressions 630. Similar to the first groove or notch 618, the second groove or notch 620 includes a base or lower surface 632 extending between first and second sidewalls 634, 636. The base or lower surface 632 of the second groove or notch 620 forms the second cam surface 616. The second cam surface 616 radially undulates. It includes radial projections or projecting surfaces 638 and valleys or depressions 640.

The motor rotates the cam member 600 about the longitudinal axis 604 in either the first or second direction 660, 662 wherein first and second cam followers 642, 644 follow the first and second cam surfaces 614, 616 to move the respective first and second locking elements 646, 648 between an initial or retracted, locking element nondeployed position and an extended, locking element deployed position. Similar to the foregoing examples, the cam member 600 has discreet positions 0/0, 0/1, 1/0, and 1/1. In one example, 0 is associated with a valley, and 1 is associated with a projection.

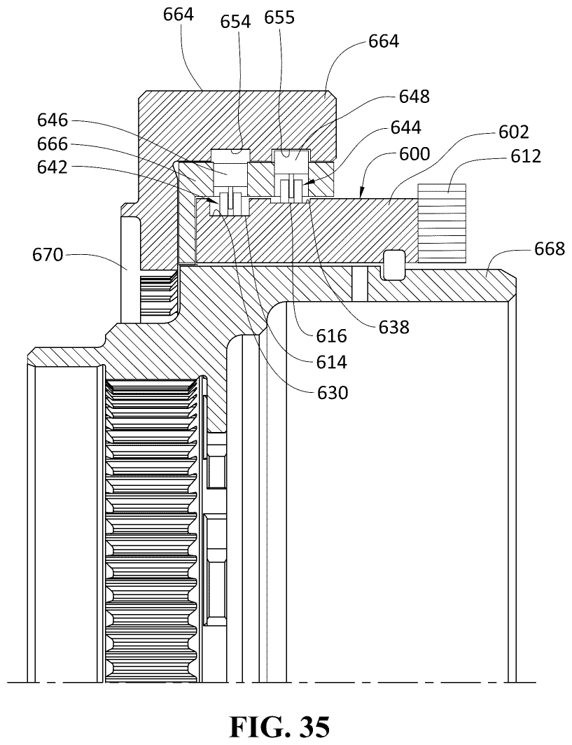

FIG. 35 shows the first cam follower 642 is located in a valley or depression 630 of the first cam surface 614, wherein the first locking element 646 is in the nondeployed position. The second cam follower 644 is located on a projection or projecting surface 638 of the second cam surface 616, wherein the second locking element 648 is in the deployed position. The example of FIG. 35 shows the actuator in a 0/1 position, the locking element 646 is nondeployed, and the locking element 648 is deployed. As with the previous examples, the position of the cam member 600 and corresponding first and second cam surfaces 614, 616 repositions the projections or projecting surfaces 628, 638 and or depression of the respective cam surfaces 614, 616 to place the actuators in the different modes. For example, if the first and second cam followers 642, 644 are on the respective projections or projecting surfaces 628, 638 of the first and second cam surfaces 614, 616, the actuator is positioned in a 1/1 mode wherein both the first and second locking elements 646, 648 are deployed.

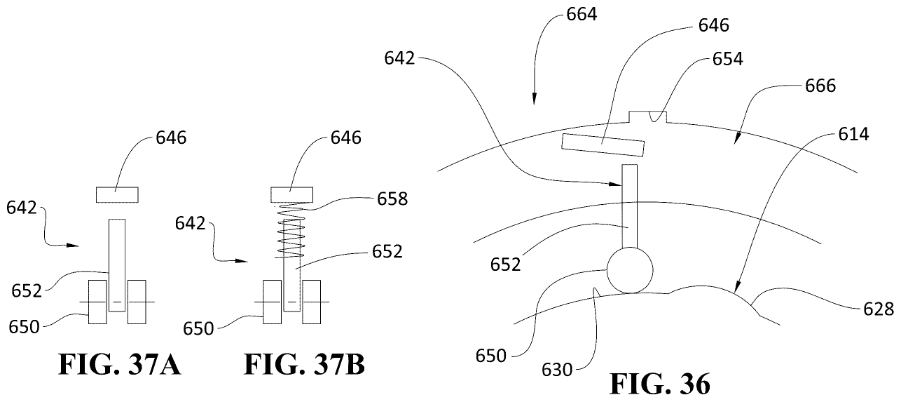

FIGS. 36 and 37A-37B schematically illustrate other examples of the first and second cam followers 642, 644. FIG. 36 illustrates one example of the first cam follower 642 including a roller 650 engaging and following the valley or depression 630 of the first cam surface 614. A plunger 652 is pivotably or rotatably connected to the roller 650. The plunger 652 engages the first locking element 646 and biases the first locking element 646 radially outward into engagement with a notch 654 in the notch plate 664 when the roller 650 engages the projection or projecting surface 628 of the first cam surface 614. The projection or projecting surface 628 causes the plunger 652 to move radially outward and reposition the first locking element 646 into a deployed position. FIGS. 37-37B schematically illustrate side views of alternative examples of the first cam follower 642. The first cam follower 642, shown in FIG. 37B includes an actuation spring 658 connected on one end to the plunger 652 and engaging the first locking element 646 on the opposite end. Accordingly, as the plunger 652 moves radially outward, the spring 658 acts on the first locking element 646. The same or similar structures may be used for the second cam follower 644 to act on and reposition the second locking element 648 into a deployed position, wherein it engages a notch 655 in the notch plate.

As with the foregoing example, based on the combination of the deployed and non-deployed positions, the first and second locking elements 642 648 mechanically couple the coupling members together, for example, a notch plate 664 and a pocket plate 666. The pocket plate 666 connects to the first power component, for example, a driveshaft 668, and the notch plate 664 connects to the second power component, for example, a driven shaft 670.

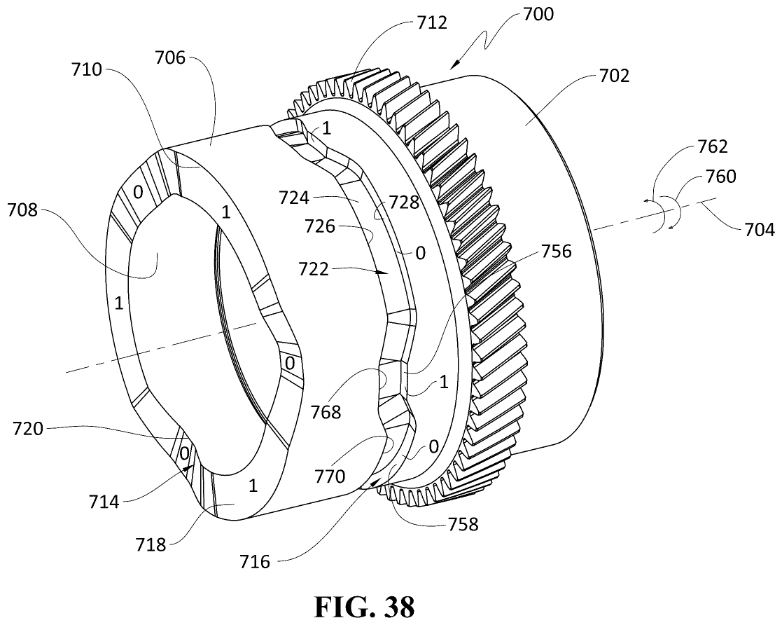

FIGS. 38-40 illustrate another example of a cam member 700 for use with an actuator operative to move locking elements between a first deployed position and a second nondeployed position. Like previous examples, the cam member 700 has a cylindrically shaped body 702 extending along a longitudinal axis 704. The cylindrically shaped body 702 includes an outer peripheral surface 706 and an inner peripheral surface 708. The cylindrically shaped body 702 includes an end surface 710 extending between the outer peripheral surface 706 and the inner peripheral surface 708. A plurality of gear teeth 712, for example, a ring gear, are located on the outer peripheral surface 606. The gear teeth 712 engage another gear member, for example, a worm gear. The worm gear operates in conjunction with the gear teeth 712 to rotate the cam member 700 about the longitudinal axis 704 in either a first direction 760 or a second direction 762.

The cam member 700 includes a first cam surface 714 on the end surface 710 and a second cam surface 716 on the outer peripheral surface 706. The first cam surface 714 is a longitudinal cam surface, wherein the cam surface varies in the longitudinal or axial direction, the direction of the longitudinal axis 704. In one example the first cam surface 714 includes a longitudinally extending projection or projecting surface 718 in between adjacent valleys or depressions 720. The second cam surface 716 is part of a circumferential groove or notch 722 in the outer peripheral surface 706. As shown in FIG. 38, the circumferential groove or notch 722 includes a base 724 extending between first and second sidewalls 726, 728 of the circumferential groove or notch 722. In one example, the second sidewall 728 forms the cam surface 716, with the second sidewall 728 shifting longitudinally in the direction of the longitudinal axis 704. In one example the second cam surface 714 includes a longitudinally extending projection or projecting surface 756 in between adjacent depressions or valleys 758.

Depending upon the selected position of the cam member 700, the interaction between the cam surfaces 714, 716 of the cam member 700 and a first cam follower 730, associated with the first cam surface 714, and a second cam follower 732, associated with the second cam surface 716, respective first and second locking elements 734, 736 move between an initial or retracted, locking element non-deployed position and an extended, locking element deployed positions. Based on the combination of the deployed and non-deployed positions, the first and second locking elements 734, 736 mechanically couple the coupling members together, in one example, a notch plate 780 and a pocket plate 782.

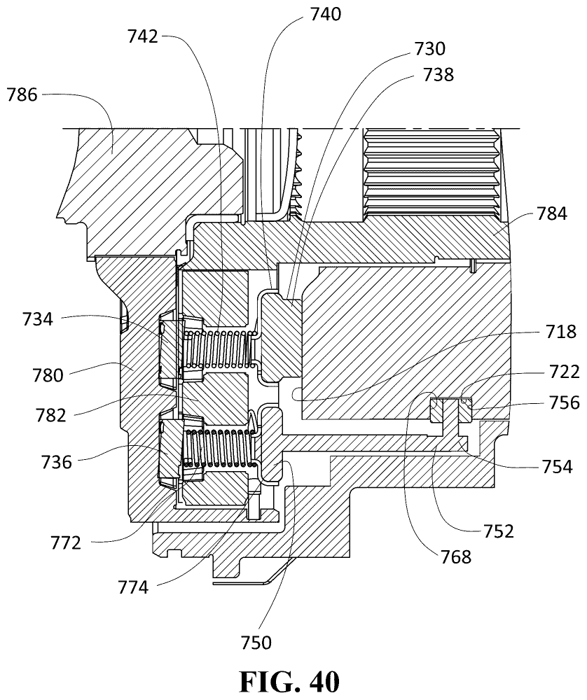

Similar to the example shown in FIG. 32, as shown in FIG. 40 the cam member 700 acts on the first cam follower 730. The first cam follower 730 includes a thrust plate or portion 738, engaging a spring plate 740. An actuation member, for example, an actuation spring 742, extends between the spring plate 740 and the first locking element 734. When the first cam follower 730 contacts a projection or projecting surface 718 on the first cam surface 714, the thrust plate or portion 738 of the first cam follower 730 extends or moves the first cam follower 730, including thrust plate or portion 738, the spring plate 740, and the actuation spring 742 wherein the actuation spring 742 acts on the first locking element 734 placing it in a deployed position. When the first cam follower 730 contacts the valley or depression 720 on the first cam surface 714, the first locking element 734 is placed in a nondeployed position.

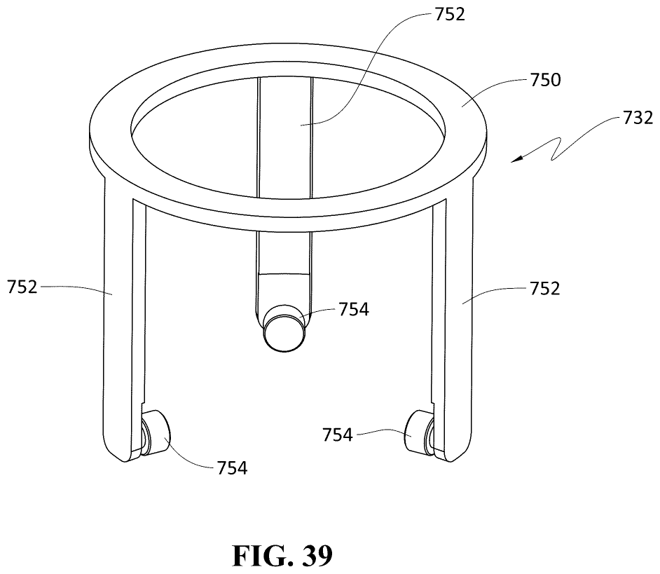

FIG. 39 shows one example of the second cam follower 732, including an annular member 750, a plurality of legs 752, and a plurality of rollers 754. The rollers 754 connect to and extend radially inward from the legs 752. As shown in FIG. 40 the rollers 754 are located in the circumferential groove or notch 722 and engage the corresponding projection or projecting surface 756 of the second sidewall 728 and the valley or depression 768 on the opposed first sidewall 726, wherein the annular member 750 and a spring plate 774 act on an actuation member, for example, an actuation spring 772 and places the second locking element 736 in a deployed position. Rotation of the cam member 700 in either the first direction or the second direction 760, 762 moves the second cam follower 732 in the longitudinal direction and correspondingly moves the second locking element 736 between a deployed position and a nondeployed position.

While the first sidewall 726 acts as a cam surface, the projection or projecting surface 770 acts with the valley 758 wherein the rollers 754 and the annular member 750 move rearward and correspondingly move the second locking elements 736 to a nondeployed position. In another example, a return spring could also act on the annular member 750 or spring plate 740 to move the second cam follower 732 in a rearward direction, toward the gear teeth 712, and keep the rollers 754 in contact with the second sidewall 728. In this instance, the second sidewall 728 is the second cam surface 716.

Similar to the previous embodiment, the motor rotates the cam member 700 about the longitudinal axis 704 in either the first or second direction 760, 762, wherein first and second cam followers 730, 732 follow the first and second cam surfaces 714, 716 to move the respective first and second locking elements 734, 736 between an initial or retracted, locking element nondeployed position and an extended, locking element deployed position. The cam member 700 has discreet positions 0/0, 0/1, 1/0, and 1/1 wherein, in one example, 0 is associated with a valley 758, and 1 is associated with a projection or projecting surface 756.

FIG. 40 shows the first cam follower 730 located adjacent to a projection or projecting surface 718 of the first cam surface 714, wherein the first locking element 734 is in a deployed position. The second cam follower 732 is located on a projection or projecting surface 756 of the second sidewall 728, wherein the second locking element 736 is in the deployed position. FIG. 40 shows the actuator in a 1/1 position wherein both the first and second locking elements 734, 736 are deployed. As with the previous examples, the position of the cam member 700 and corresponding first and second cam surfaces 714, 716 in relation to the cam followers 730, 732 place the actuator in other modes.

As with the foregoing examples, based on the combination of the deployed and non-deployed positions, the first and second locking elements 734, 736 mechanically couple the coupling members together, for example, a notch plate 780 and a pocket plate 782. The pocket plate 782 connects to the first power component, for example a driveshaft 784, and the notch plate 70 connects to the second power component, for example a driven shaft 786.

The cam members of the foregoing examples operate to translate the rotary motion of the respective cam members about the longitudinal axis into longitudinal or radial motion of respective cam followers. The cam followers then act to assist in positioning the locking elements in a deployed or nondeployed position.

While exemplary embodiments are described above, it is not intended that these embodiments describe all possible forms of the present invention. The words used in the specification are words of description rather than limitation, and it is understood that various changes may be made without departing from the spirit and scope of the present invention. Additionally, the features of various implementing embodiments may be combined to form further embodiments of the present invention.

The description of the invention is merely exemplary in nature; thus, variations that do not depart from the gist of the invention are intended to be within the scope of the invention. Such variations are not to be regarded as a departure from the spirit and scope of the invention.

What is claimed is:

1. An actuation mechanism comprising:
a cam member including a first cam surface and a second cam surface;
the second cam surface spaced from the first cam surface,
a first cam follower, first cam follower following the first cam surface;
a second cam follower, the second cam follower following the second cam surface;
a first link between the first cam follower and a first coupling member; and
a second link between the second cam follower and a second coupling member.

2. The actuation mechanism of claim 1 wherein:
the first cam surface is a longitudinal cam surface varying in a direction parallel to a rotational axis of the cam member; and
the second cam surface is a longitudinal cam surface varying in a direction parallel to the rotational axis of the cam member.

3. The actuation mechanism of claim 2 wherein:
the first cam follower is rotatably fixed and axially movable relative to the rotational axis, the first cam follower contacting and following the first cam surface; and
the second cam follower is axially movable relative to the rotational axis, the second cam follower contacting and following the second cam surface.

4. The actuation mechanism of claim 1 wherein:
the first cam surface and the second cam surface are spaced concentrically.

5. The actuation mechanism of claim 1 wherein:
the first cam surface and the second cam surface are spaced longitudinally on the cam member.

6. The actuation mechanism of claim 1 wherein:
the first cam surface is a longitudinal cam surface varying in a direction parallel to a rotational axis of the cam member; and
the second cam surface is a radial cam surface varying in a direction transverse to a rotational axis of the cam member.

7. The actuation mechanism of claim 6 wherein:
the first cam follower is rotatably fixed and axially movable relative to the rotational axis, the first cam follower contacting and following the first cam surface; and
the second cam follower is rotatably fixed and radially movable relative to the rotational axis, the second cam follower contacting and following the second cam surface.

8. The actuation mechanism of claim 6 wherein:
the first cam surface and the second cam surface are spaced longitudinally on the cam member.

9. The actuation mechanism of claim 1 wherein:
the first cam surface is a radial cam surface varying in a direction transverse to a rotational axis of the cam member; and
the second cam surface is a radial cam surface varying in a direction transverse to a rotational axis of the cam member.

10. The actuation mechanism of claim 9 wherein:
the first cam follower is radially movable relative to the rotational axis, the first cam follower contacting and following the first cam surface; and
the second cam follower is radially movable relative to the rotational axis, the second cam follower contacting and following the second cam surface.

11. The actuation mechanism of claim 9 wherein:
the first cam surface and the second cam surface are spaced longitudinally on the cam member.

12. The actuation mechanism of claim 1 wherein the first cam follower and the second cam follower move independently.

13. An actuator comprising:
a cam member rotatable about a rotational axis, the cam member having a end surface extending between an outer peripheral surface and an inner peripheral surface;
the cam member having a first cam surface and a second cam surface;
the first cam surface having a cam profile;
the second cam surface having a cam profile;
a first cam follower following the cam profile of the first cam surface wherein the first cam follower moves between an extended position and a retracted position based on the cam profile of the first cam surface; and
a second cam follower following the cam profile of the second cam surface, wherein the second cam follower moves between an extended position and a retracted position based on the cam profile of the second cam surface.

14. The actuator of claim 13 including:
the cam profile of the first cam surface is on the end surface; and
a groove in the outer peripheral surface of the cam member, a sidewall of the groove forming the second cam surface.

15. The actuator of claim 13 including:
the cam profile of the first cam surface is on the end surface; and
a groove in the outer peripheral surface of the cam member, a base of the groove forming the second cam surface.

16. The actuator of claim 13 including:
a first groove in the outer peripheral surface of the cam member, the first groove including the cam profile of the first cam surface; and
a second groove spaced from the first groove, the second groove including the cam profile of the second cam surface.

17. The actuator of claim 13 wherein:
the first cam follower is connected to and moves a first locking element, and the second cam follower is connected to and moves a second locking element.

18. A system comprising:
a first component;
a second component;
first and second coupling members supported for rotation relative to one another in first and second directions about a rotational axis, the first coupling member fixed to the first component and the second coupling member fixed to the second component;
a first locking element movable between a deployed position in which the first locking element mechanically couples the first and second coupling members together and a non-deployed position in which the first and second coupling members are not mechanically coupled together;
a second locking element movable between a deployed position in which the second locking element mechanically couples the first and second coupling members together and a non-deployed position in which the first and second coupling members are not mechanically coupled together;
an actuator including a cam member rotatably movable and axially fixed relative to the rotational axis, the cam member having a first cam surface and a second cam surface, the first cam surface spaced from the second cam surface;
a first cam follower movable relative to the rotational axis, the first cam follower contacting and following the first cam surface;
a second cam follower movable relative to the rotational axis, the second cam follower contacting and following the second cam surface; and
the cam member moves the first and second cam followers to a first position wherein both the first and second cam followers are extended, a second position wherein both the first and second cam followers are retracted, and a third position wherein one of the first cam follower and the second cam follower is extended and the other cam follower is retracted.

19. The system of claim 18 wherein:
the first cam surface is longitudinally spaced from the second cam surface on the cam member, each of the first cam surface and the second cam surface is a longitudinal cam surface wherein the first and second cam followers move longitudinally relative to the rotational axis.

20. The system of claim 18 wherein:
the first cam surface is longitudinally spaced from the second cam surface on the cam member, the first cam surface is a longitudinal cam surface and the second cam surface is a radial cam surface wherein the first cam follower moves longitudinally relative to the rotational axis and the second cam follower moves radially relative to the rotational axis.

21. The system of claim 18 wherein:
the first cam surface is longitudinally spaced from the second cam surface on the cam member, the first cam surface is a radial cam and the second cam surface is a radial cam surface wherein the first cam follower moves radially relative to the rotational axis and the second cam follower moves radially relative to the rotational axis.
